(19) United States
(12) Patent Application Publication
(10) Pub. No.: US 2008/0314035 A1
(43) Pub. Date: Dec. 25, 2008

(54) Temperature Ladder and Applications Thereof

(76) Inventor: Lincoln Evan-Beauchamp, Palo Alto, CA (US)

Correspondence Address: PETERS VERNY , L.L.P., 425 SHERMAN AVENUE, SUITE 230, PALO ALTO, CA, 94306, US

(21) Appl. No.: 12/202,186

(22) Filed: Aug. 29, 2008

Related U.S. Application Data
(63) Continuation-in-part of application No. 11/800,110, filed on May 3, 2007.
Application No. 11/800,110 is a continuation-in-part of application No. 11/787,851, filed on Apr. 17, 2007.
Application No. 11/787,851 is a continuation-in-part of application No. 11/404,424, filed on Apr. 14, 2006.
Application No. 11/404,424 is a continuation-in-part of application No. 11/412,289, filed on Apr. 26, 2006.
Application No. 11/412,289 is a continuation-in-part of application No. 11/412,481, filed on Apr. 26, 2006.

(51) Int. Cl. F01N 3/20; F02B 33/34; F28D 15/00

(52) U.S. Cl. 60/300; 60/624; 165/104.12

(57) ABSTRACT

A reverse flow heat exchanger is combined with an energy source to generate a temperature ladder. This system is used to create temperatures at which particles within a gas flow are combusted. Applications described include cleaning of particle laden gas, raising the temperature of a catalyst, exhaust cleaning and room air cleaning.

### CROSS-REFERENCE TO RELATED APPLICATIONS

This application is a continuation-in-part of U.S. patent application Ser. No. 11/800,110 filed May 3, 2007 and entitled “Particle Burner disposed between an Engine and a Turbo Charger,” which is a continuation-in-part of U.S. patent application Ser. No. 11/787,851 filed Apr. 17, 2007 and titled “Particle Burner including a Catalyst Booster for Exhaust Systems,” which is a continuation-in-part of U.S. patent application Ser. No. 11/404,424 filed Apr. 14, 2006 and titled “Particle Burning in an Exhaust System,” a continuation-in-part of U.S. patent application Ser. No. 11/412,289 filed Apr. 26, 2006 and titled “Air Purification System Employing Particle Burning,” and a continuation-in-part of U.S. patent application Ser. No. 11/412,481 filed Apr. 26, 2006 and titled “Reverse Flow Heat Exchanger for Exhaust Systems.” The disclosures of all of the above U.S. patent applications are hereby incorporated herein by reference.

### BACKGROUND OF THE INVENTION

1. Field of the Invention

This invention relates generally to exhaust cleaning systems and air cleaning systems.

2. Description of the Prior Art

When a fuel burns incompletely, pollutants such as particles and hydrocarbons are released into the atmosphere. The United States Environmental Protection Agency has passed regulations that limit the amount of pollutants that, for example, diesel trucks, power plants, generators, engines, automobiles, and off-road vehicles can release into the atmosphere.

Currently, industries attempt to follow these regulations by adding scrubbers, catalytic converters and particle traps to their exhaust systems. However, these solutions increase the amount of back pressure exerted on the engine or combustion system, decreasing system performance. In addition, the scrubbers, catalytic converters and particle traps themselves become clogged by particles and require periodic cleaning to minimize back pressure.

Radiation sources and heaters have been used in exhaust systems, for example, to periodically clean the particle traps or filter beds. Others solutions have included injecting fuel into the filter beds or exhaust streams as the exhaust enters the filter beds to combust the particles therein. However, the filter beds can be sensitive to high temperatures and the radiation sources and heaters must be turned off periodically.

Air purification systems currently use one of two methods to remove particles such as dust, biological toxins, pet dander, dust, and the like from the air in a room. One type of system uses an ionizer to provide a surface charge to the air-borne particles so that they adhere to a surface. However, ionizers emit ozone, a respiratory irritant, into the air. Another type of system uses a filter, such as a HEPA filter, to trap particles as the air flows through the filter. However, filters need to be replaced or cleaned periodically. Both methods typically require a fan to efficiently circulate the air, which requires electricity and can be loud.

Catalyst systems reduce a toxicity of emissions from an internal combustion engine by providing an environment for a chemical reaction wherein toxic combustion by-products are converted to less-toxic substances. Some of the reactions may include oxidizing carbon monoxide to carbon dioxide, oxidizing unburnt hydrocarbons to carbon dioxide and water, and reducing nitrogen oxides to nitrogen and oxygen. These reactions have a net exothermic effect. Conventional catalysts system dump heat generated from the exothermic reaction into the environment.

It is known to capture heat energy from an exhaust stream using a recuperator. A recuperator is used to transfer some of the heat energy from the exhaust stream to cool fresh air before the cool fresh air enters a turbine. This cools the exhaust stream and heats the cool fresh air and, thus, recoups some of the heat energy.

### SUMMARY OF THE INVENTION

Various embodiments of the invention include a temperature ladder configured for the destruction of particles or other reactions. The temperature ladder comprises a reverse flow heat exchanger and an energy source disposed at an intermediate point within the heat exchanger. As is described further elsewhere herein, the addition of energy at an intermediate point within the reverse flow heat exchanger results in a feedback effect that causes the region in which energy is introduced to reach a high temperature.

Some embodiments include an exhaust system comprising a combustion chamber and an energy source. The combustion chamber is elevated to a high temperature using the temperature ladder. The energy source is arranged with respect to the combustion chamber, either inside or outside of the chamber, so as to be able to add energy to gasses within the combustion chamber. The energy source can comprise a resistive heating element, a coherent or incoherent infrared emitter, or a microwave emitter, a flame, an inductive coil, or the like. For example, a microwave emitter can be tuned to a particular molecular bond. Where the energy source is disposed outside of the combustion chamber, the energy source can either heat the chamber walls to reradiate into the chamber; else the combustion chamber can include a radiation transparent window.

Particles in an exhaust stream passing through the combustion chamber are heated by the energy source to their combustion temperature and are consequently removed from the exhaust by burning. Microwave radiation tuned to excite a molecular bond found in the particles can be particularly effective for heating the particles rapidly. Additional air or fuel can be added to the combustion chamber, as needed, to promote better combustion. Once a combustion front is established in the combustion chamber, the combustion reaction can become self-sustaining so that further energy from the energy source is no longer required. Exhaust entering the reverse flow heat exchanger is heated as it travels toward the combustion changer, and exhaust having passed through the combustion chamber is used to heat the pre-combustion chamber gas.

In various embodiments, the combustion chamber has a circular or non-circular cross-section in a plane perpendicular to a longitudinal axis of the chamber. In some of these embodiments, the cross-section is at least partially parabolic to focus heat from the burning particles back into a hot zone within the combustion chamber where the particle burning preferentially occurs. The combustion chamber can be thermally insulated to better retain heat in order to maintain the combustion reaction. The exhaust system can also comprise a thermally insulated exhaust pipe leading to the combustion chamber to further reduce the loss of heat from the exhaust stream before particle burning can occur. In some embodiments, a reverse flow heat exchanger is placed in fluid communication with the combustion chamber so that heat is transferred to the incoming exhaust stream from the combusted exhaust stream exiting the combustion chamber. In certain embodiments, the reverse flow heat exchanger is also thermally insulated.

Various embodiments of the present invention are configured to eliminate particles without the use of an obstructing particle filter or trap. The absence of a particle filter or trap within the combustion chamber allows for a non-restrictive flow path and reduces backpressure relative to systems that employ a filter or trap. In other embodiments, a particle filter or trap is disposed after the combustion chamber. In these embodiments most (e.g., greater than 80, 90, 95 or 99%) of the particles are burned prior to reaching the particle filter or trap. The particle filter or trap therefore needs to be cleaned or replaced much less often. For example, a particle filter may be configured to pass nano-sized ash that is the product of combustion but block larger particles.

In some embodiments, a vehicle comprising an internal combustion engine and the exhaust system described above is also provided. The exhaust system optionally serves as either or both of a muffler and a catalytic converter. Thus, the combustion chamber and/or reverse flow heat exchanger can also include a catalyst. In some embodiments, the combustion chamber and/or the reverse flow heat exchanger can be sized to act as a resonating chamber to serve as a muffler. For example, the combustion chamber can have a diameter greater than a diameter of the exhaust pipe leading into the combustion chamber. The vehicle can also comprise a controller configured to control the energy source.

The systems described herein can be implemented in a variety of settings where particles are present in a gas stream for the combustion of these particles. Various embodiments include gasoline engine exhaust systems, diesel exhaust systems, power plant emission systems, fireplace chimneys, air cleaning devices, ship propulsion systems, aircraft, generators, vehicle exhaust systems, air purification systems, dust reduction systems, or other sources of particle laden air.

The systems described herein may also be implemented in settings wherein a catalyst is used to remove undesirable compounds from a gas stream. For example, the systems may be used to elevate a catalyst and/or gas stream to a working temperature. Likewise, the systems may be used to maintain the catalyst and/or gas stream at the working temperature. Some embodiments are configured for both combustion of particles and operation of a catalyst. In these embodiments, the particles are optionally combusted prior to passing of the gas stream through the catalyst. If interaction of the exhaust with the catalyst is exothermic, the catalyst may function as the energy source or a part thereof

Some embodiments include an air purification system. This system optionally comprises a spiral reverse flow heat exchanger, including two ducts, spiral-wound around or above a combustion chamber. The reverse flow heat exchanger receives particle-laden air into the combustion chamber. In the combustion chamber, the particles are burned, which heats the air. The exiting air, substantially particle-free, exits the combustion chamber at an elevated temperature. The reverse flow heat exchanger transfers the heat from the exiting air to preheat the particle-laden air entering the combustion chamber. Air circulation may be accomplished using a fan or through the rising of the heated air.

In some embodiments, an exhaust system comprises a reverse flow heat exchanger including a plate defining a surface and separating an exit chamber and an intake chamber. Each chamber of the heat exchanger has an inlet and an outlet located at opposing ends to allow flow therethrough. The exhaust system also comprises a first manifold coupled to the reverse flow heat exchanger and in fluid communication with the intake chamber inlet.

A vane is optionally disposed within the first manifold is situated relative to the intake chamber inlet so as to reduce resistance to fluid flow near the intake chamber inlet. The exhaust system can also comprise a heating manifold that receives exhaust from the intake chamber, heats the exhaust, and returns the exhaust to the exit chamber. In some embodiments, the heating manifold includes a combustion chamber for burning particles in the exhaust. In these embodiments the exhaust system can also comprise an energy source for heating the particles to at least a combustion temperature.

Another exemplary exhaust system comprises a first manifold and a reverse flow heat exchanger coupled to the first manifold. Here, the reverse flow heat exchanger defines a transverse plane and includes a plurality of parallel plates in a stacked geometry separating a number of chambers, each chamber having an inlet and an outlet. These chambers comprise a set of intake chambers alternating with a set of exit chambers, where the inlets of the intake chambers being in fluid communication with the first manifold and the outlets of the intake chambers being in fluid communication with the inlets of the exit chambers. The exhaust system can further comprise a heating manifold coupled to the reverse flow heat exchanger to provide the fluid communication between the outlets of the intake chambers and the inlets of the exit chambers.

In some embodiments an exhaust cleaner comprises a reverse flow heat exchanger and a gas permeable catalyst. The reverse flow heat exchanger includes a first duct interleaved with a second duct, where each duct is spiral-wound around a central volume. The first and second ducts are also in fluid communication with each other across the central volume. The gas permeable catalyst is optionally disposed within the central volume and separates the central volume into first and second regions. The first duct of the reverse flow heat exchanger opens into the first region, and the second duct of the reverse flow heat exchanger opens into the second region. In some embodiments, the catalyst comprises a substrate and a catalytic material. Additionally, the central volume can further comprise a heating element or other energy source.

An exemplary vehicle comprises an internal combustion engine and an exhaust system configured to receive exhaust from the internal combustion engine. The exhaust system includes an exhaust cleaner comprising a reverse flow heat exchanger and a gas permeable catalyst. The reverse flow heat exchanger includes a first duct interleaved with a second duct, where each duct is optionally spiral-wound around a central volume. The first and second ducts are also in fluid communication with each other across the central volume. The gas permeable catalyst is disposed within or near by the central volume and optionally separates the central volume into first and second regions. The first duct of the reverse flow heat exchanger opens into the first region, and the second duct of the reverse flow heat exchanger opens into the second region. In some of these embodiments, the exhaust cleaner further comprises an inlet chamber and an outlet chamber, wherein the inlet chamber is in fluid communication with the first duct and the outlet chamber is in fluid communication with the second duct. The inlet chamber can include vanes that protrude into the inlet chamber, and the outlet chamber can include vanes extending outward.

An exemplary method for cleaning vehicle or other exhaust is also provided. The method comprises heating exhaust from an internal combustion engine in a first duct of a reverse flow heat exchanger, passing the exhaust from the first duct, through a gas permeable catalyst, and into a second duct of the reverse flow heat exchanger, where catalysis of incomplete combustion products at the catalyst heats the catalyst and further heats the exhaust, and cooling the exhaust within the second duct by transferring heat to the first duct. Here, the ducts of the reverse flow heat exchanger can be interleaved and/or spiral-wound. The method can also comprise monitoring a temperature of the catalyst. In some of these embodiments, the method further comprises employing a heating means to heat the exhaust whenever the temperature of the catalyst is below a threshold.

Yet another exemplary embodiment of the invention comprises an engine, a turbo charger including an impeller and a turbine, and a particle burner disposed between the engine and the turbine and configured to receive exhaust from the engine. The system can comprise a vehicle or a stationary system such as a power plant or generator, for example. The engine can be a diesel engine, an aircraft engine, or a gasoline engine, in various embodiments.

Yet another exemplary method comprises burning fuel in an engine to produce an exhaust including particles, using the exhaust to drive a turbine of a turbo charger, and heating the exhaust to a combustion temperature of the particles before using the exhaust to drive the turbine. In some embodiments, heating the exhaust includes generating heat by catalyzing the further combustion of gaseous products of incomplete combustion. Heating the exhaust can also include passing the exhaust through a reverse flow heat exchanger. The reverse flow heat exchanger can comprise two interleaved ducts, and in some instances the ducts are spiral-wound.

### BRIEF DESCRIPTION OF THE FIGURES

FIG. 1 depicts a system for burning particles in an exhaust system in accordance with various embodiments of the invention.

FIG. 2 depicts a system for burning particles in an exhaust system in accordance with various embodiments of the invention.

FIG. 3 depicts a system for burning particles in an exhaust system in accordance with various embodiments of the invention.

FIG. 4 depicts a system for burning particles in an exhaust system in accordance with various embodiments of the invention.

FIG. 5A depicts a cross sectional view of the system for burning particles further comprising a reverse flow heat exchanger in accordance with various embodiments of the invention.

FIG. 5B illustrates temperature as a function of position in the system of FIG. 5A at various times according to various embodiments of the invention.

FIG. 6 depicts a schematic representation of a vehicle comprising an internal combustion engine and an exhaust system in accordance with various embodiments of the invention.

FIG. 7 depicts a cross sectional view taken perpendicular to a vertical axis of an exemplary spiral reverse flow heat exchanger and combustion chamber in an air purification system in accordance with various embodiments of the invention.

FIG. 8 depicts a cross sectional view along a vertical axis of the air purification system in accordance with various embodiments of the invention.

FIG. 9 is a flow chart depicting a method for purifying air in accordance with various embodiments of the invention.

FIGS. 10 and 11 depict top and front views, respectively, of an exemplary system for burning particles in an exhaust system in accordance with various embodiments of the invention.

FIGS. 12 and 13 depict cross sections of the intake chamber and exit chamber, respectively, of the system shown in FIGS. 10 and 11 in accordance with various embodiments of the invention.

FIG. 14 depicts a cross section taken along the line 14-14 of FIG. 11 in accordance with various embodiments of the invention.

FIG. 15 depicts a cross section taken along the line 15-15 of FIG. 11 in accordance with various embodiments of the invention.

FIG. 16 depicts a cross section taken along the line 16-16 of FIG. 10 in accordance with various embodiments of the invention.

FIGS. 17 and 18 depict top and front views, respectively, of an exemplary system for burning particles in an exhaust system in accordance with various embodiments of the invention.

FIGS. 19 and 20 depict cross sections of the intake chamber and exit chamber, respectively, of the system shown in FIGS. 17 and 18 in accordance with various embodiments of the invention.

FIG. 21 depicts a cross section taken along the line 21-21 of FIG. 17 with several alternative implementations of a vane in accordance with various embodiments of the invention.

FIG. 22 depicts a cross section taken along the line 22-22 of FIG. 17 in accordance with various embodiments of the invention.

FIG. 23 depicts a cross sectional view taken perpendicular to a vertical axis of an exemplary reverse flow heat exchanger and catalyst in an exhaust system in accordance with various embodiments of the invention.

FIGS. 24 and 25 show top and side views, respectively, of an exemplary exhaust system in accordance with various embodiments of the invention.

FIG. 26 depicts a cross section of an exhaust system taken along line 26-26 of FIG. 25 in accordance with various embodiments of the invention.

FIG. 27 depicts a schematic representation of a particle burner disposed between an engine and a turbo charger according to various embodiments of the invention.

### DETAILED DESCRIPTION

An exhaust system comprises a combustion chamber and an energy source to facilitate the combustion of particles within the chamber. Once ignited, the combustion can continue and may be self-sustaining so long as the concentration of combustible particles in the exhaust entering the chamber remains sufficiently high. In some embodiments, the disclosed device can replace both the muffler and the catalytic converter in a vehicle exhaust system and offers reduced back pressure for better fuel economy and lower maintenance costs. The device requires little to no maintenance and is self-cleaning.

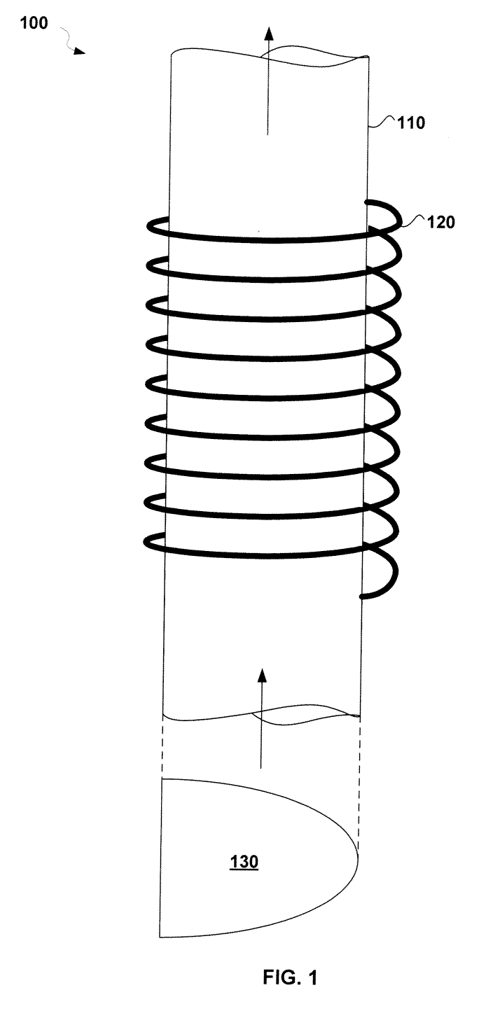

FIG. 1 depicts an exhaust system 100 comprising a combustion chamber 110 and an energy source 120. The combustion chamber 110 can be constructed using any suitable material capable of withstanding the exhaust gases at the combustion temperature of the particles. Suitable materials include stainless steel, titanium, and ceramics, for example. In one embodiment, the combustion chamber 110 has a non-circular cross-section 130 perpendicular to a longitudinal axis of the combustion chamber 110. At least a portion of the cross-section 130 can be parabolic, circular or otherwise shaped in order to focus radiation from the combustion reaction into a hot zone within the combustion chamber 110. It will be appreciated that the combustion chamber 110, in some embodiments, can be proportioned to serve as a resonating chamber so that the combustion chamber 110 also performs as a muffler. In alternative embodiments, energy source 120 may include other energy providing devices discussed herein.

One advantage of various embodiments of the present invention is the absence of an obstructing particle filter or trap within the combustion chamber 110. A particle trap or filter is obstructing if it permanently traps un-combusted particles and, thus, as more and more un-combusted particles are trapped, reduces gas throughput through combustion chamber 110 over time. By not restricting the flow of exhaust gas through the combustion chamber 110, some embodiments of the invention serve to avoid an increase back-pressure over time as compared with prior art systems.

Energy source 120, in the illustrated embodiment, comprises a resistive heating element wrapped around the outside of the combustion chamber 110. In another embodiment, the energy source 120 is placed externally along the longitudinal length of the combustion chamber 110. In some embodiments, a controller (not shown) for the energy source 120 is provided to control the power to the energy source 120 and to turn off the energy source 120 when not needed, such as when no exhaust is flowing. Alternative embodiments of energy source 120 are discussed elsewhere herein.

In various embodiments, energy source 120 may be an internal or external energy source. For example, an internal energy source may include a catalytic converter that generates energy through reactions with exhaust gasses. An external energy source is an energy source that receives energy from an external source and provides it to combustion chamber 110. For example, a resistive heater is an external energy sources that receives energy form a battery or generator and provides this energy to combustion chamber 110. Energy source 120 may be continuous or periodic. A periodic energy source is on that provides energy to combustion chamber 110 on a single pulse basis. For example, merely to initiate a reaction. A non-continuous spark and a single induction pulse are examples of periodic energy sources. A continuous energy source is one that provides energy to combustion chamber 110 in a more continuous manner. For example, a continuous energy source is one that can be used to maintain combustion that would otherwise not be self sustaining. Examples of continuous energy sources include microwaves, a resistive electrical heater, a continuous electrical discharge (arc), or a continuously powered (e.g., more than one pulse) induction coil.

In operation, an exhaust gas containing particles, such as carbonaceous particles like soot, flows through the combustion chamber 110. An exhaust gas is a gas that has been at least partially depleted of oxygen or some other oxidizer through a combustion process. The energy source 120 heats the wall of the combustion chamber 110 which re-radiates infrared (IR) radiation into the interior of the combustion chamber 110. Some of the IR radiation is absorbed by the particles in the exhaust gas as they traverse the combustion chamber 110. When the particles reach a temperature at which they ignite, about 800° C. for carbonaceous particles, the particles may burn completely, leaving no residue. Accordingly, essentially particle-free exhaust leaves the combustion chamber 110.

The heat produced by the combustion of the particles can make the continuing reaction self-sustaining so that the energy source 120 is no longer necessary. A thermocouple (not shown) can be placed on or in the combustion chamber 110 in order to monitor the temperature of the combustion reaction to provide feedback to a controller (not shown) for controlling the power to the energy source 120. As noted above, the combustion chamber 110 can be shaped to focus IR radiation from the combustion reaction onto a focal point or line within the combustion chamber 110 to create a hot zone that helps to sustain the continuing reaction in the absence of external heating.

In other embodiments, a flame is used to burn the particles in the combustion chamber while in use and/or to initiate the combustion process. Accordingly, the combustion chamber can include a fuel inlet and an igniter to light the flame. A flame can also be used in combination with the energy source or as a part thereof. The fuel may include gasoline, diesel fuel, natural gas, hydrogen, ethanol, propane, butane, or the like.

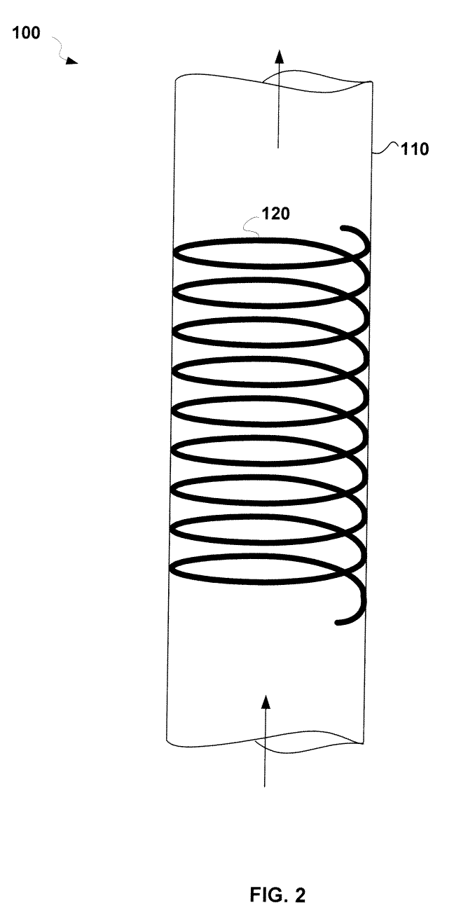

FIG. 2 depicts alternative embodiments of exhaust system 100 comprising combustion chamber 110 and energy source 120. In these embodiments, the energy source 120 is disposed within the combustion chamber 110. The energy source 120, as shown, comprises a coiled resistive heating element. As above, the energy source 120 can take other shapes and, for example, can be longitudinally disposed internally along the length of the combustion chamber 110. In those embodiments in which the energy source 120 is disposed within the combustion chamber 110, energy from the energy source 120 can directly heat the particles in the exhaust as well as heat the walls of the combustion chamber 110 as in the embodiment of FIG. 1.

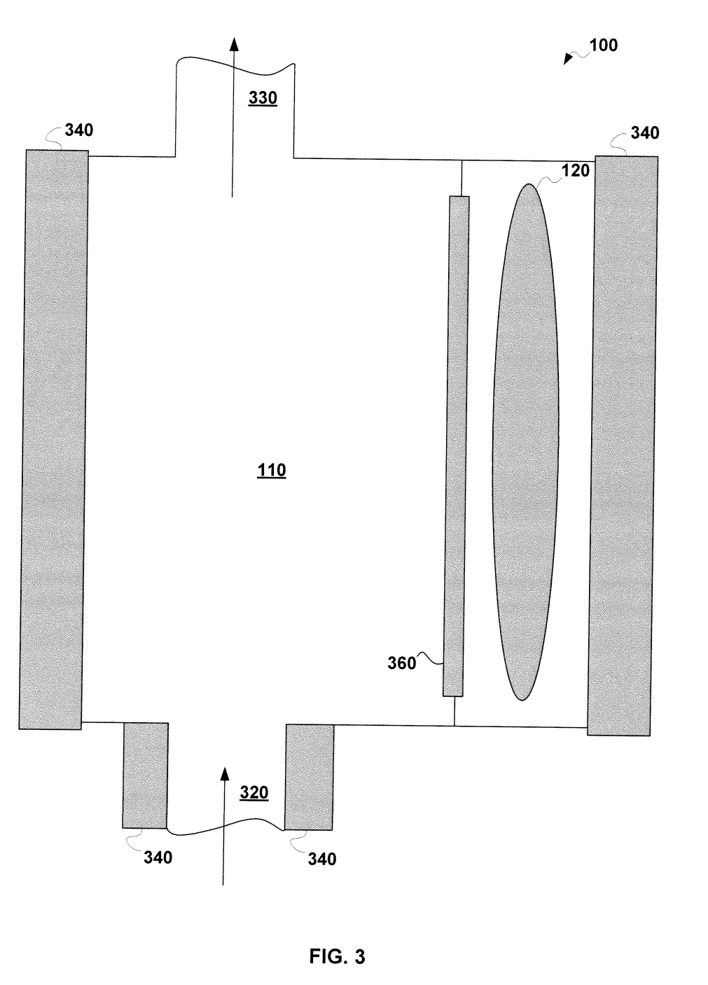

FIG. 3 depicts a cross-section of alternative embodiments of exhaust system 100 comprising combustion chamber 110 having an inlet 320 and an outlet 330, optional thermal insulation 340, an energy source 120, and a radiation transparent window 360 into the combustion chamber 110. In the illustrated embodiment, a diameter of the combustion chamber 110 is greater than a diameter of the inlet 320. This arrangement slows the exhaust gas as it enters the combustion chamber 110 and can create a muffling effect. Alternatively, the diameter of outlet 330 may be greater than the diameter of combustion chamber 110. In some embodiments, the diameters of inlet 320, combustion chamber 110 and outlet 330 are similar.

In some embodiments, the inlet 320 and/or the combustion chamber 110 are thermally insulated by the thermal insulation 340 to retain as much heat as possible in the exhaust gas as the gas enters the combustion chamber 110. It will be appreciated that insulation 340 can be similarly applied to the other embodiments disclosed herein. For example, a blanket of insulation 340 can be wrapped around the energy source 120 and combustion chamber 110 of FIG. 1.

In the embodiments illustrated by FIG. 3, energy source 120 can be, for example, a coherent or incoherent IR emitter or microwave emitter, such as a Klystron tube, or the like. Energy source 120 can be configured to emit radiation directionally and/or within a desired range of wavelengths. Accordingly, radiation transparent window 360 is provided to allow radiation to pass directly into the combustion chamber 110. In some embodiments, the radiation transparent window 360 extends completely around the circumference of the combustion chamber 110.

As noted, energy source 120 can be tuned to produce radiation within a desired range of wavelengths. Thus, the radiation can be tuned to excite specific molecular bonds that are known to be present in the particles of the exhaust stream. For example, microwave radiation can be tuned to excite carbon-hydrogen bonds or carbon-carbon bonds where the particles in the exhaust are known to include such bonds. Tuning the radiation in this manner can heat particles to their ignition temperature more quickly and with less energy.

The radiation transparent window 360 is constructed using a material that can withstand the heated exhaust gases within the combustion chamber 110. In some embodiments, radiation transparent window 360 is a microwave transparent window constructed using fiberglass, plastic, polycarbonate, quartz, porcelain, or the like. In other embodiments, the radiation transparent window 360 is an IR transparent window constructed using, for instance, sapphire.

Surfaces within inlet 320 and/or combustion chamber 110 are optionally textured so as to create improved flow properties therein. For example, a textured surface may result in more efficient heat exchange or a thicker boundary layer between flowing gasses and the surface. Texturing may include mere roughening of the surface or may include the addition of projections from the surface into the gas flow.

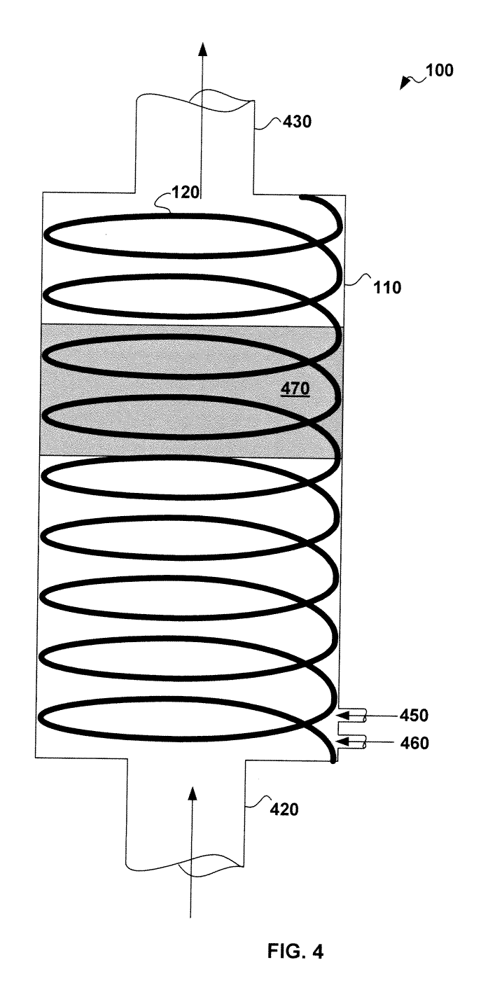

FIG. 4 depicts an alternative embodiment of exhaust system 100 to illustrate other optional components that can be employed in conjunction with any of the preceding embodiments. In these embodiments, exhaust system 100 comprises a combustion chamber 110 having an inlet 420 and an outlet 430, energy source 120, an air inlet 450, a fuel intake 460, and a catalyst 470. As in the previous example, the combustion chamber 110 can have a greater diameter than the inlet 420 and the outlet 430. Alternatively, the outlet 430 can have the same diameter as combustion chamber 110. The energy source 120, as shown, is a resistive heating element disposed within the combustion chamber 410, but can alternatively be disposed externally and can alternatively be an IR or microwave emitter, or other instance of energy source 120.

The combustion chamber 410 may comprise air intake 450 and/or fuel intake 460. In some embodiments, air intake 450 is configured to introduce oxygen to the combustion chamber to aid the combustion reaction in the event that there is not enough oxygen present in the exhaust as it enters the combustion chamber 410. In some embodiments, fuel intake 460 introduces fuel into the combustion chamber to burn and, thus, heat the exhaust as it enters through inlet 420. It will be appreciated that adding fuel with or without air can, in some instances, replace the need for the energy source 120. In such embodiments, a spark generator or other ignition source can be employed to ignite the combustion reaction with the added fuel.

In certain embodiments, the combustion chamber 410 additionally comprises at least one catalyst 470 to catalyze oxidation and/or reduction reactions in the exhaust stream. The catalyst 470 can include platinum, rhodium, palladium, and/or the like deposited on a honeycomb substrate or ceramic beads. In these embodiments, the combustion chamber 410 is configured to additionally function as a catalytic converter in the exhaust system 100. It will be understood that heating the exhaust gas in the presence of the catalyst 470 can advantageously improve the completeness of the reaction being catalyzed. The catalyst 470 may be 2-way or 3-way, and may be configured to operate at temperatures between roughly 750 and 900° C.

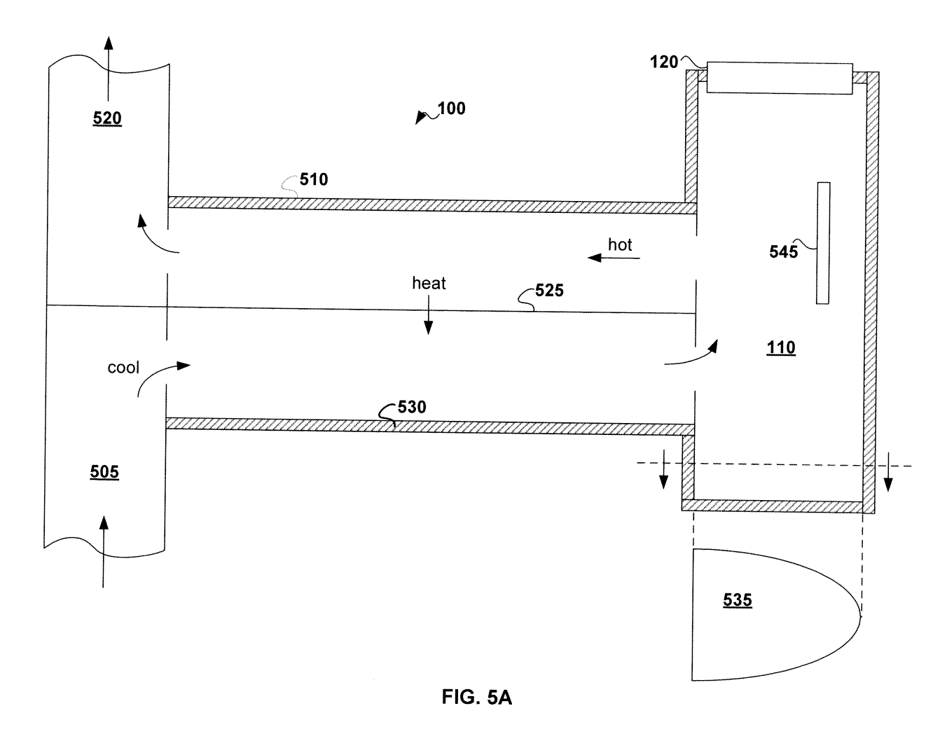

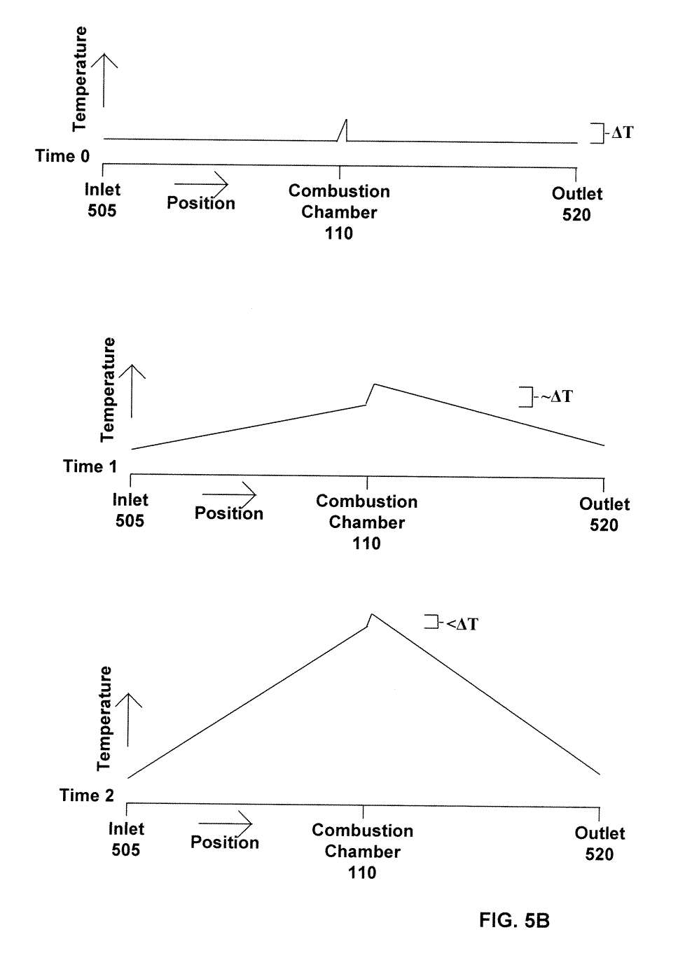

FIG. 5A depicts an alternative embodiment of exhaust system 100 comprising an inlet 505, a reverse flow heat exchanger 510, combustion chamber 110, and an outlet 520. The heat exchanger 510 serves to pre-heat the exhaust before the exhaust enters the combustion chamber 110. The heat exchanger 510 can also serve as a muffler, in some embodiments. Heat exchanger 510 is separated into two or more sections by at least one wall 525. Exhaust enters the exhaust system 100 via the inlet 505 and is directed into one section of the heat exchanger 510. Heated gases exiting the combustion chamber 110 through another section of the heat exchanger 510 transfer heat to the incoming gases through the wall 525. In some embodiments, the heat exchanger 510 and/or the combustion chamber 110 are insulated by thermal insulation 530. As in other embodiments described herein, the inlet 505 can also be thermally insulated.

In some embodiments, the combustion chamber 110 has a circular, parabolic or partially parabolic cross-section 535 perpendicular to a longitudinal axis to create a hot zone. The combustion chamber 110 also comprises energy source 120. In some embodiments, a radiation transparent window separates the energy source 120 from the combustion chamber 110.

In some embodiments, the exhaust system 100 further comprises at least one catalyst 545 configured to catalyze oxidation and/or reduction reactions of undesirable gases in the exhaust stream such as NOₓ compounds. In those embodiments where the heat exchanger 510 is configured to act as a muffler, and the combustion chamber 110 comprises catalyst 545, it will be appreciated that the exhaust system 100 can replace both the muffler and the catalytic converter in a conventional vehicle exhaust system. Advantageously, because the combustion chamber 110 burns the particles present in the exhaust stream, it will be further appreciated that the exhaust system 100 can additionally replace a particle trap in a conventional exhaust system.

Catalyst 545 may be placed in combustion chamber 110, at an exit of combustion chamber 110 or in the region of heat exchanger 510 following the combustion chamber 110. By placing catalyst 545 in one or more of these positions particles are burned in combustion chamber 110 before they have a chance to reach catalyst 545. As such, catalyst 545 has a reduced chance of becoming fouled or contaminated. Catalyst 545 may be placed following combustion chamber 110 if a preferred operating temperature of catalyst 545 is lower than the operating temperature of combustion chamber 110. For example, in various embodiments, the temperature within combustion chamber 110 is greater than approximately 537, 600 or 650° C., while the temperature at catalyst 545 may be less than these values.

In various embodiments, the change in temperature between the exhaust at inlet 505 and combustion chamber 110 is at least 100, 200, 350, 500 or 600 degrees C. In some embodiments, it is desirable to have a minimal pressure differential between inlet 505 and outlet 520. For example, to maintain the efficiency of an engine it is sometimes preferable to restrict exhaust flow as little as possible. The pressure differential between inlet 505 and outlet 520 is less than 3, 2, 1.5, 1.0, 0.5, 0.25 or 0.1 atm. The pressure within combustion chamber may vary according to the application. For example, if exhaust system 100 is used to process the exhaust of a diesel truck, the pressure may be on the order of 2 atm. If exhaust system 100 is used to process the exhaust of a diesel engine in a typical locomotive or ship the pressure may be closer to 8 atm.

It should be noted that in some embodiments the catalyst 545 comprises a substrate, such as a grating, with a surface coating of a catalytic material that is placed over an opening 550 of the heat exchanger 510 or within heat exchanger 510. While such a catalyst 545 may at least partially restrict the flow of exhaust gas through the combustion chamber 110, the catalyst is not considered a particle trap or filter. Specifically, openings in the catalyst substrate are too large to trap or filter the remaining nano-sized ash particles in the exhaust following combustion. Additionally, such a catalyst 545 tends not to collect particles for at least two reasons. First, particles are mostly eliminated from the exhaust by combustion before the exhaust reaches the catalyst 545. Second, even if a group of particles survives the combustion reaction and adheres to the catalyst 545, the restriction around the particles would cause a local increase in temperature which would cause the particles to burn and not be retained thereon.

Likewise, some embodiments that employ a microwave emitter as the energy source 120 include a microwave-blocking grating (not shown) either across the opening 550 or further downstream along the exhaust path to prevent microwaves from propagating out of the exhaust system 100. For essentially the reasons discussed above, although such a microwave-blocking grating may at least partially restrict the flow of exhaust gas through the combustion chamber 110, the microwave-blocking grating is not a particle trap or filter. Specifically, the openings of the grating are too large to trap or filter particles in the exhaust, particles are eliminated from the exhaust before the exhaust reaches the microwave-blocking grating, and any particles that survive and adhere to the microwave-blocking grating simply burn off.

FIG. 5B illustrates temperature as a function of position in the system of FIG. 5A at various times. These positions are along a gas flow path between inlet 505 and outlet 520. At startup (Time 0) energy source 120 provides a change in temperature of ΔT at combustion chamber 110. Other areas of combustion chamber 110 are at ambient temperature. At a Time 1 gasses that have received the temperature increase of ΔT travel into the reverse-flow heat exchanger 510 toward outlet 520. Heat from these gasses traverse through wall 525 and heat gas that has yet to enter combustion chamber 110. The gas now entering the combustion chamber 110 is now preheated. When this preheated gas receives energy from energy source 120 it is again heated by approximately ΔT. However, because the gas was preheated the absolute temperature reached is now higher than at Time 0. The reverse-flow heat exchanger thereby produces a feedback effect wherein an energy input can be used to increase the temperature at an intermediate point within the heat exchanger. Through this process the temperature in the combustion chamber 110 is elevated until a steady state is reached at a Time 2. Gas leaving through outlet 520 is slightly hotter than gas entering inlet 505. This temperature difference is a function of the efficiency of the reverse-flow heat exchanger 510. This process of raising temperature within the combustion chamber and the systems used to perform this process are referred to herein as a temperature ladder. A temperature ladder can increase both the temperature which gases reach and the amount of time they are at an elevated temperature.

In some embodiments, a steady state is reached when the energy provided by energy source 120 is equal to the energy difference between gas entering inlet 505 and gas exiting outlet 520 plus energy lost through walls of exhaust system 100. In some embodiments, a steady state is reached when the temperature within combustion chamber 110 is the same as a temperature of energy source 120. Under these conditions energy source 120 no longer adds energy to the gases within combustion chamber 110. In some embodiments, a steady state is reached because the temperature rise achieved per unit of energy added to the exhaust gasses declines as the absolute temperature increases. As a result the temperature rise (ΔT) in the combustion chamber at Time 0 may be greater than the temperature rise achieved at steady state at Time 2.

Different types of energy source 120 may result in different types of steady states. For example if energy source 120 includes a flame then the maximum temperature of combustion chamber 110 is the temperature of this flame. If energy source 120 includes a microwave source, then energy source 120 may provide energy to gasses within combustion chamber 110 irrespective of temperature over a wide temperature range.

The presence of reverse-flow heat exchanger 510 and combustion chamber 110 result in any particles in the exhaust gas being raised to a higher temperature and heated for a longer time than would be achieved by combustion chamber 110 alone. In various embodiments, the combustion chamber 110 operates at least 100, 200, 300, 400 degrees C. greater than the temperature of gasses entering the reverse-flow heat exchanger 510. When the combustion of particle is exothermic, energy released by the combustion is added to the system. For example, burning some carbon containing particles may release energy. This energy supplements the energy provided by energy source 120 and under some conditions is sufficient to maintain combustion after energy source 120 is turned off or turned down. The burning of particles may occur at a combustion front at which the gas temperature reaches the particle combustion temperature. This combustion front may be within combustion chamber 110 or may travel into the reverse-flow heat exchanger toward inlet 505. Combustion may increase both the temperature and pressure of the exhaust gasses.

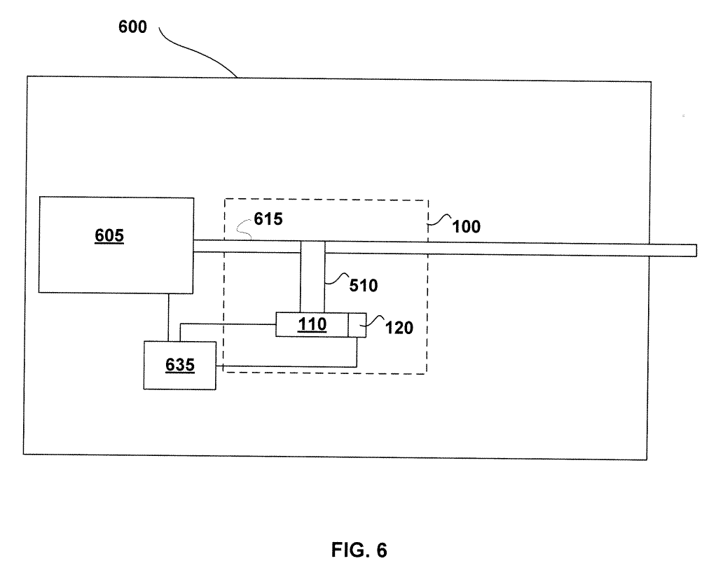

FIG. 6 shows a schematic representation of a vehicle 600 comprising an internal combustion engine 605 such as a diesel engine. The vehicle 600 also comprises an exhaust system 100 that includes an exhaust pipe 615 from the engine 605 to reverse flow heat exchanger 510, a combustion chamber 110, and energy source 120. The vehicle 600 further comprises a controller 635 for controlling the power to the energy source. The controller 635 can be coupled to the engine 605 so as to control the amount of energy provided by energy source 120 when the engine is not operating, for example. The controller 635 can also control the energy source 120 in a manner that is responsive to engine 605 operating conditions. Further, the controller 635 can also control the energy source 120 according to conditions in the combustion chamber 110. For instance, the controller 635 can monitor a thermocouple in the combustion chamber 110 so that no power goes to the energy source 120 when the temperature within the combustion chamber 110 is sufficiently high to maintain a self-sustaining combustion reaction.

An alternative embodiment of the invention comprises an air purifier such as for a hospital room, a clean room, a factory, an office, a residence, or the like. An exemplary air purification system comprises a combustion chamber and a means for heating particles to at least an ignition temperature of particles within the chamber. A reverse flow heat exchanger is wrapped around or adjacent to the combustion chamber to recycle excess heat from the exiting air to the entering air. The means for heating can be energy source 120 or the like.

Unlike the exhaust systems described previously herein, these embodiments are designed for environments in which the concentration of particles in the incoming air is low. Therefore, in embodiments that employ an energy source, the energy source is typically run constantly to maintain the combustion of the particles. Additionally, or alternatively, a fuel can be supplied to the combustion chamber to compensate for the lower concentration of particles. Like the exhaust systems discussed elsewhere herein, this further air purifier requires little to no maintenance and is self-cleaning. Advantageously, some embodiments of the air purifier do not require a continuous energy source and or a fan to maintain air movement.

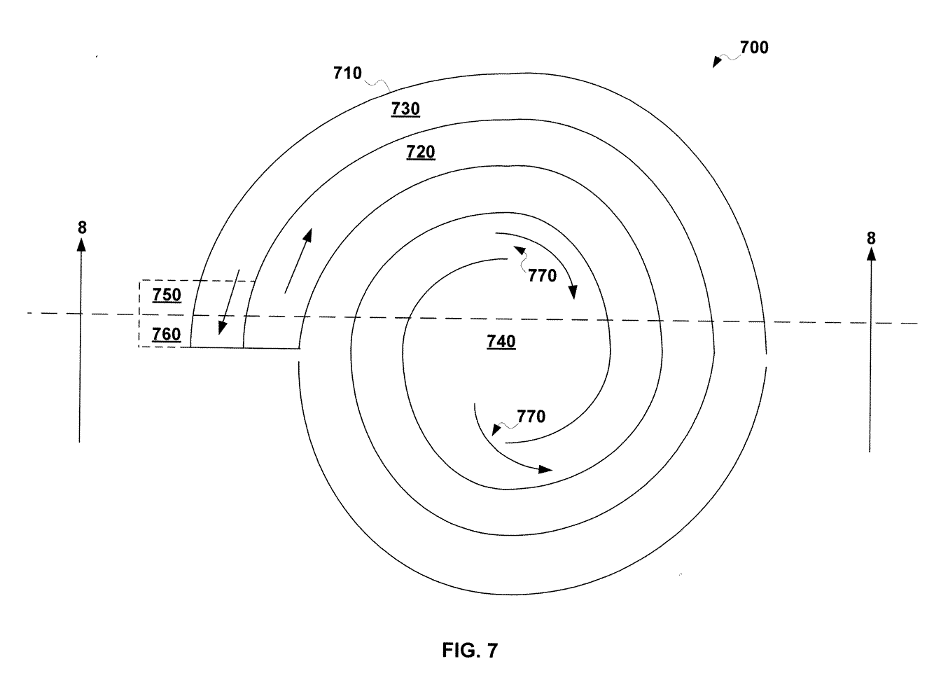

FIG. 7 depicts a cross sectional view of an air purification system 700. The cross section depicted is taken perpendicular to a vertical axis of the air purification system 700. A reverse flow heat exchanger 710 comprises two ducts, an incoming duct 720 and an outgoing duct 730 coiled around a combustion chamber 740. Combustion chamber 740 is an alternative embodiment of combustion chamber 110 and reverse flow heat exchanger 710 is an alternative embodiment of reverse flow heat exchanger 510. The air purification system 700 also comprises an inlet 750 and an outlet 760 shown in dashed lines to represent that these components are optionally out of the plane of the drawing. The inlet 750 is an opening through which particle-laden air enters the incoming duct 720 of the reverse flow heat exchanger 710. The outlet 760 is an opening through which substantially particle-free air leaves the outgoing duct 730 of the reverse flow heat exchanger 710. Typically, the reverse flow heat exchanger 710 and the combustion chamber 740 are constructed using stainless steel, but other suitable materials will be familiar to those skilled in the art.

The reverse flow heat exchanger 710 transfers heat from the air exiting the combustion chamber 740 to the particle-laden air entering the combustion chamber 740. After the particle-laden air enters the combustion chamber 740, the particles are burned and the air exits the combustion chamber 740 substantially particle-free. As particles, including dust, biological toxins, pollen, other examples provided herein, and the like, typically combust before or at about 800° C., the air exiting the combustion chamber 740 may be significantly warmer than room temperature. This excess heat is transferred from the air exiting the combustion chamber 740 through the walls of the reverse flow heat exchanger 710 to preheat the incoming particle-laden air. In some embodiments, the heat exchanger 710 acts as insulation for the combustion chamber 740, making the air purification system 700 safer and more energy efficient.

In some embodiments, an optional fan (not shown), can be placed at the inlet 750 and/or the outlet 760 to improve air flow through the air purification system 700. At the outlet 760, for instance, the fan draws air out from the air purification system 700. The fan can be run continuously, periodically, or when the air purification system 700 is first activated. The fan can be connected to a control circuit and/or temperature sensor described elsewhere herein.

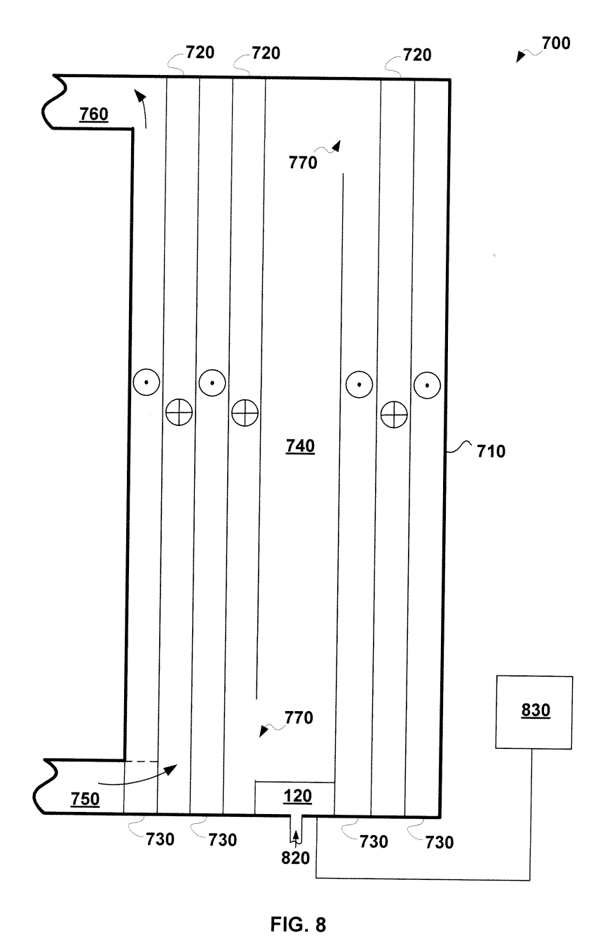

Combustion chamber 740 is optionally coupled to incoming duct 720 and outgoing duct 730 by vents 770. Vents 770 may be open along the entire length of combustion chamber 740, or as illustrated in FIG. 8, may be disposed at specific parts of combustion chamber 740.

FIG. 8 depicts a cross sectional view of the air purification system 700 along a line 8-8 as noted in FIG. 7. The reverse flow heat exchanger 710 includes an inlet 750 and an outlet 760. An incoming duct 720 is depicted using an arrow pointing into the page. An outgoing duct 730 is depicted using an arrow pointing out of the page. The inlet 750 and the outlet 760 are optionally located at opposite ends of the air purification system 700. When the system is operated in a vertical orientation, outlet 760 is optionally above inlet 750.

In some embodiments, the air purification system 700 has a height dimension approximately equal to the height of a room in which the air purification system 700 will be installed. Accordingly, the inlet 750 can be near the floor while the outlet 760 can be near the ceiling, or vice-versa. This height ensures that most of the air in the room circulates through the air purification system 700. Other dimensions, including the number of windings, the spacings between the walls, and the like can be determined by one skilled in the art. For example, in various embodiments, air purification system 700 has a height between 2-3 feet, between 2.5 to 4.5 feet, or greater than 4 feet.

The air purification system 700 also includes energy source 120. Energy source 120 can be disposed near the bottom or top of the combustion chamber 740 or in another location, such as at an intermediate position within the combustion chamber 740. Energy source 120 heats air within combustion chamber. This causes the air to rise through convection. The rising air draws further air in to combustion chamber 740 from the incoming ducts 720 via the lower of vents 770 and pushes air out of combustion chamber into one of outgoing ducts 730 via the higher of vents 770. As this process continues, the incoming air is preheated by the outgoing air and the temperature within the combustion chamber increases as described elsewhere herein. Eventually, the temperature within the combustion chamber 740 reaches the combustion temperature particles within the incoming air. Burning these particles cleans the air and may add additional energy to combustion chamber 740. For example, the combustion of particles from a relatively clean burning engine may add 1.6° C. while combustion of particles from a relatively dirty engine may add 28° C. to the temperature of the exhaust.

The air purification system 700 may additionally include a control circuit 830 to monitor and control the combustion and flow rate through the air purification system 700. For example, control circuit 830 may control operation of energy source 120 by controlling current to a heater, power to a microwave source, fuel flow through a fuel inlet 820, or the like. In some embodiments, control circuit 830 is configured to monitor the temperature within combustion chamber 740, e.g. using a thermal couple, and to control the operation of energy source 120 responsive to this temperature. In some embodiments, control circuit 830 is configured to maintain combustion chamber 740 at a target temperature. For example, control circuit 830 may be configured to reduce or eliminate the energy supplied to combustion chamber 740 via energy source 120 if the air received by combustion chamber 740 includes enough particles to provide energy via combustion. A control circuit similar to control circuit 830 may be included in other embodiments of the invention disclosed herein.

The air turnover rate in a room can be varied as needed. An appropriate rate will depend on factors such as the size of the room, air cleanliness requirements for the room, energy efficiency, and the like. For example, in a hospital room or an industrial clean room, where very clean air is required, the air turnover rate can be set significantly higher than in an office where energy efficiency can be more important. The turnover rate can be increased by increasing the flow rate through the air purifier, for example, by increasing the rate at which energy is provided using energy source 120.

In some embodiments air purification system 700 includes a fan to help facilitate the flow if air through the system. This fan is typically disposed near the entrance of inlet 750 or the exit of outlet 760. The fan is optionally controlled by control circuit 830. The spacing and/or sizes of incoming ducts 720, outgoing ducts 730 and combustion chamber 740 are optionally configured to muffle any noise produced by the fan.

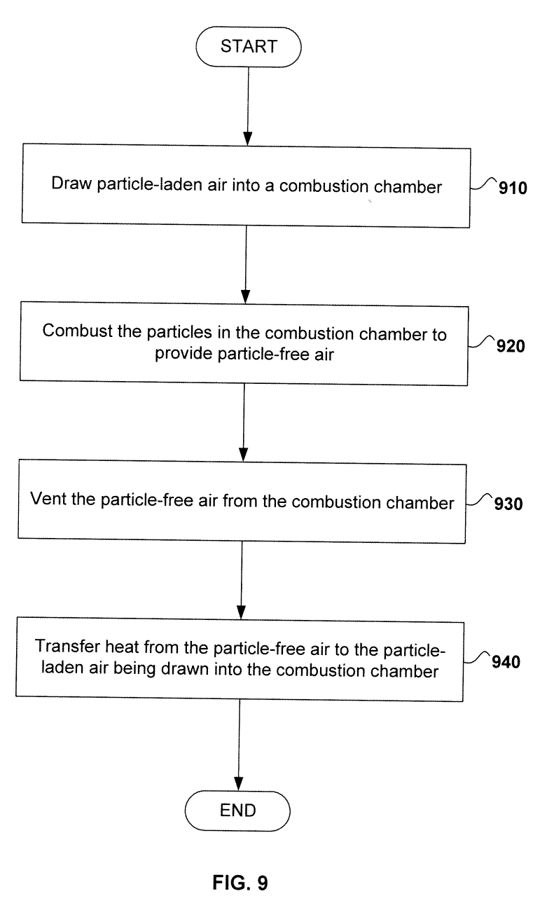

FIG. 9 is a flowchart depicting a method for purifying air. In a step 910, particle-laden air is drawn into a combustion chamber, e.g. combustion chamber 740. In some embodiments, the particle-laden air is drawn in behind the heated rising air in the combustion chamber 740 or by, for example, a fan. In other embodiments, the particle-laden air is drawn in by the process of convection as air is headed by energy source 120. In step 920, the particles in the combustion chamber 740 are combusted to provide particle-free air. The combustion reaction is caused by radiation or heat energy within the combustion chamber 740. This energy is provided by energy source 120. For example, in some embodiments, a fuel source, such as a propane or butane source can be in fluid communication with the fuel inlet 820. As the fuel mixed with the particle-laden air combusts, the reaction creates heat, further heating other particles to a combustion point. In other embodiments, energy source 120 comprises an electric heater under the control of control circuit 830. After the combustion reaction, the air is substantially particle-free.

In step 930 the particle-free air is vented from the combustion chamber 740. As the heated particle-free air rises by convection and expands, it establishes a circulation through the air purification system 700 which forces the particle-free air out of the combustion chamber 740 and through the outgoing duct 730, venting the air. Additionally, a fan can assist the venting of the air.

In step 940, heat from the now particle-free air is transferred to the particle-laden air being drawn into the combustion chamber 740. This step can be performed using, e.g. heat exchanger 710. By transferring heat from the particle-free air to the particle-laden air, the particle-laden air is pre-heated prior to combustion which results in greater overall energy efficiency and a temperature ladder.

Another embodiment of the invention is directed to an exhaust system having a stacked geometry. This exhaust system comprises a reverse flow heat exchanger coupled to a means for heating the exhaust gas, such as a combustion chamber for burning particles carried by the exhaust gas. The reverse flow heat exchanger recovers heat from the exhaust gas after passing through the heating means and transfers the heat to the exhaust gas entering the heating means. The heat recovery increases the energy efficiency of the exhaust system and provides further advantages as described elsewhere herein.

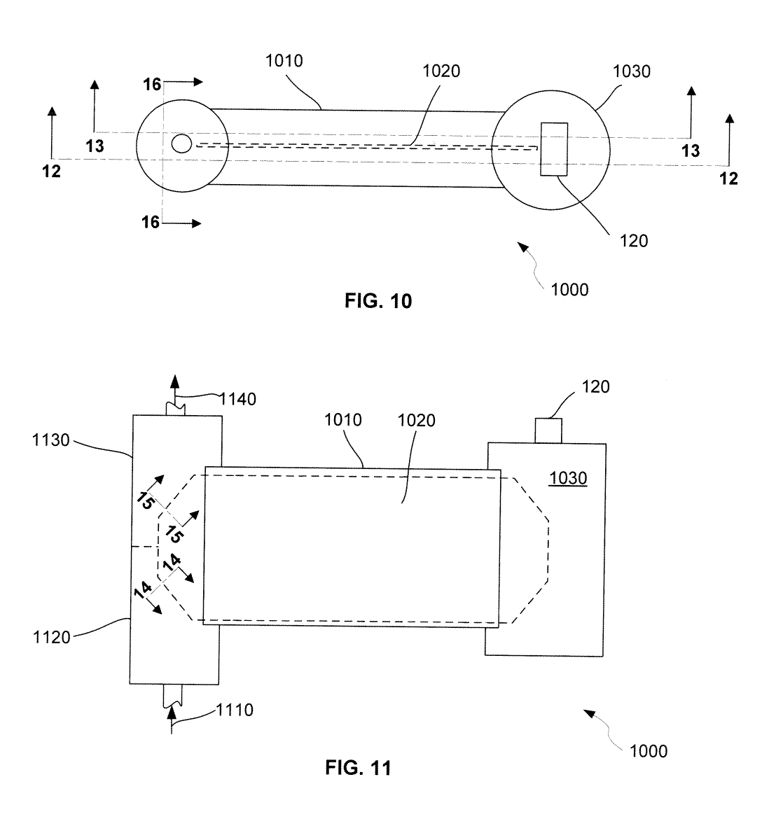

FIGS. 10 and 11 show top and front views, respectively, of an exemplary exhaust system 1000. The exhaust system 1000 is generally applicable and can be included, for example, as part of a vehicle, a power plant, a fireplace, or other sources of particle laden air discussed herein. Exhaust system 100 and the components thereof represent alternative embodiments of exhaust system 100 and components thereof, respectively. The embodiment depicted in FIGS. 10 and 11 comprises a reverse flow heat exchanger 1010 including two chambers separated by a plate 1020 (shown in dashed lines to indicate that the plate is internal to the heat exchanger 1010). One chamber of the heat exchanger 1010 is in fluid communication between a first manifold 1120 and a combustion chamber 1030. A second chamber of the heat exchanger 1010 is in fluid communication between the combustion chamber 1030 and a second manifold 1130. The chambers within the heat exchanger 1010 are described in greater detail below and comprise illustrative embodiments of the systems illustrated in FIGS. 1-6. The heat exchanger 1010 including the plate 1020, the combustion chamber 1030, and the manifolds 1120, 1130 can be constructed using any suitable material capable of withstanding the exhaust gases at the operating temperature of the exhaust system 1000. Suitable materials include stainless steel, titanium, and ceramics, for example. The plate 1020 should be constructed of a material with high thermal conductivity, such as a metal, to provide good heat transfer between the chambers.

In operation, exhaust gas 1110 from a particle laden source such as a diesel engine enter the manifold 1120 and are directed through the heat exchanger 1010 to the combustion chamber 1030. In the illustrated embodiment, particles within the exhaust are burned in the combustion chamber 1030, increasing the temperature of the exhaust gas. Combustion of the particles is facilitated by energy source 120 attached to the combustion chamber 1030.

The heated exhaust gas 1140 exits the combustion chamber 1030, passes back through the heat exchanger 1010, and leaves the exhaust system 1000 through the manifold 1130. In the heat exchanger 1010, heat from the hot gas 1140 exiting the combustion chamber 1030 is transferred to the incoming exhaust gas 1110 from the manifold 1120 through the plate 1020. By using the residual heat of the combustion of the particles to heat the incoming exhaust gas 1110, the exhaust system 1000 utilizes less energy. Other advantages of the heat exchanger 1010 are discussed elsewhere herein.

It will be appreciated that although the illustrated embodiment in FIGS. 10 and 11 includes a combustion chamber 1030, the present invention is not limited to exhaust systems including a discrete combustion chamber. While the heat exchanger 1010 is typically coupled to some heating source to raise the temperature of the exhaust gas, the combustion chamber 1030 is merely one example. The combustion chamber 1030 can be replaced, for example, with a catalytic converter comprising a catalytic material supported on a substrate that is heated by a resistive heating element. The region in which combustion takes place (combustion chamber 1030) may be indistinguishable from other parts of heat exchanger 1010. In general terms, the combustion chamber 1030 is an example of a heating manifold that heats the exhaust gas from the intake chamber 1210 of the heat exchanger 1010 and returns it to the exit chamber 1310 of the heat exchanger 1010.

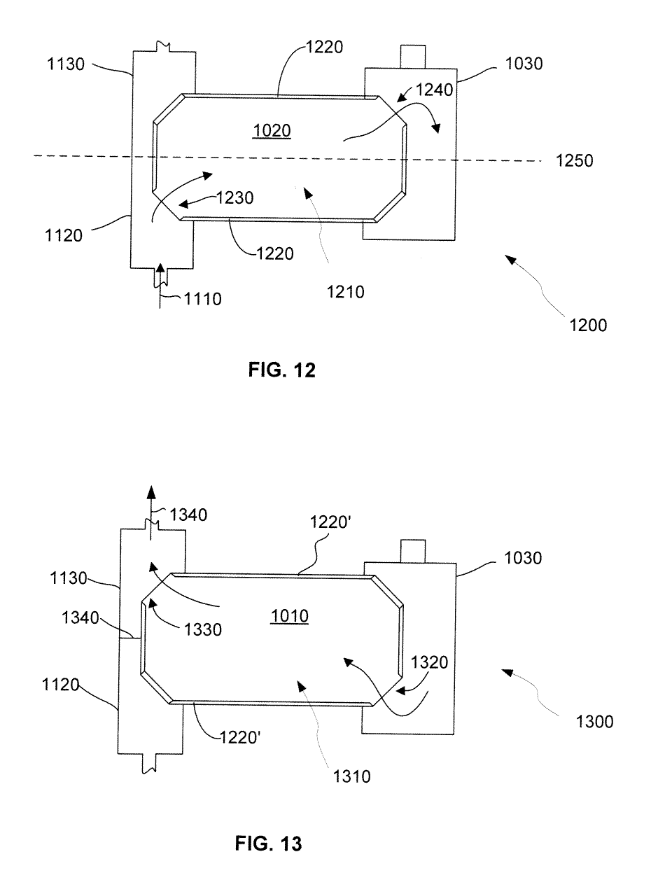

FIG. 12 and FIG. 13 are cross sections of the exhaust system 1000. In FIG. 12, a cross section 1200 is taken along section 12-12 in FIG. 10 through an intake chamber 1210. The intake chamber 1210 is formed between the plate 1020, an exterior wall of the heat exchanger 1010 (not visible in this perspective), and two spacers 1220 that maintain a proper spacing between the exterior wall and the plate 1020. Openings between the spacers 1220 form an inlet 1230 and an outlet 1240 of the intake chamber 1210. The inlet 1230 and the outlet 1240 provide fluid communication between the intake chamber 1210 and the manifold 1120 and the combustion chamber 1030, respectively.

The cross section 1200 is characterized by a transverse surface 1250, seen edge on in FIG. 12, which bisects the heat exchanger 1010 along a longitudinal axis thereof. In this embodiment, the inlet 1230 is below the transverse surface 1250 and the outlet 1240 is above the transverse surface 1250. Placing the inlet 1230 and outlet 1240 on opposite sides of the transverse surface 1250 causes the exhaust gas to traverse a diagonal of the intake chamber 1210.

In FIG. 13, a cross section 1300 is taken along section 13-13 in FIG. 10 through an exit chamber 1310. The exit chamber 1310 is formed between the plate 1020 (not visible in this perspective), another exterior wall of the heat exchanger 1010, and two spacers 1220′. As above, openings between the spacers 1220′ form an inlet 1320 and an outlet 1330 that provide fluid communication with the combustion chamber 1030 and the manifold 1130, respectively. In various embodiments, manifolds 1120 and 1130 consist of a continuous tube separated by a baffle 1340, generally aligned with the transverse surface 1250, configured to prevent fluid communication between manifolds 1120 and 1130. In these embodiments, the manifolds 1120 and 1130 share a common longitudinal axis that is approximately parallel to a plane defined by the plate 1020 and perpendicular to the transverse surface 1250.

In the illustrated embodiment, the inlet 1320 is below the transverse surface 1250 and the outlet 1330 is above the transverse surface 1250. As with the intake chamber 1210, the inlet 1320 and outlet 1330 are on opposite sides of the transverse surface 1250 so that the fluid flow is diagonal across the exit chamber 1310. Arranging the fluid flows along the diagonals of the two chambers 1210, 1310 provides the exhaust gases 1110 and 1140 greater opportunity to transfer heat therebetween.

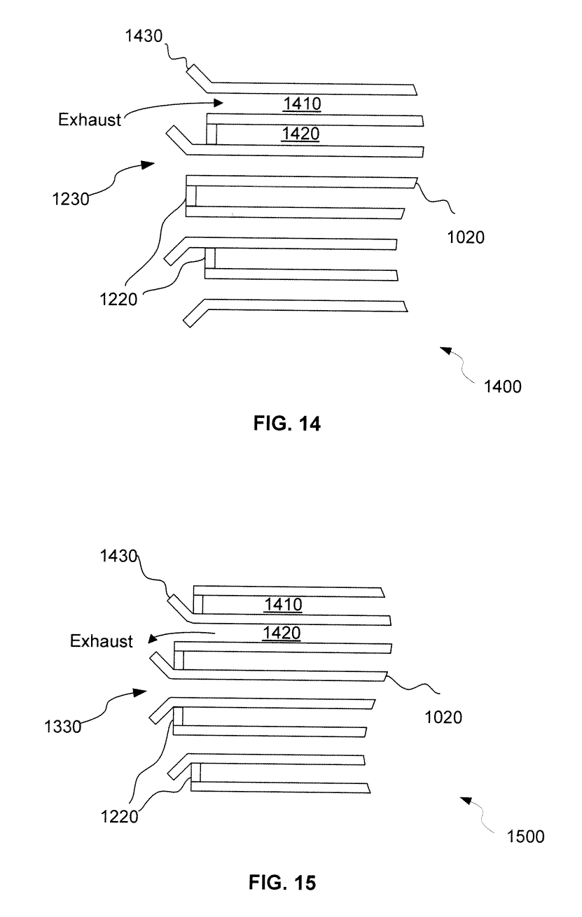

Some embodiments of the heat exchanger 1010 include multiple plates 1020 to form multiple alternating intake and exit chambers 1210, 1310 to provide even greater heat transfer. Exhaust gasses may flow between the plates in serial or in parallel. FIGS. 10 and 11 are also representative of these embodiments. FIG. 14 shows a cross section 1400 taken along the section 14-14 in FIG. 11 of an exhaust system 1000 including multiple plates 1020. Cross section 1400 shows the multiple plates 1020 forming alternating intake chambers 1410 and exit chambers 1420 where the intake chambers 1410 are open to receive exhaust from the manifold 1120. Similar to the above chambers 1210, 1310, each of the chambers 1410, 1420 are formed by two plates 1020 separated by spacers 1220 with openings therebetween to provide inlets and outlets. It will be appreciated that in these embodiments, as well as in the embodiments with only a single set of chambers 1210, 1310, the external walls of the heat exchanger 1010 can also be plates 1020. One method of forming the heat exchanger 1010 is to assemble a stack of alternating plates 1020 and spacers 1220 and to weld or bolt the assembly together in a stacked geometry.

The manifold 1120 can also include one or more vanes disposed relative to an intake chamber inlet 1230 to reduce resistance to fluid flow near that intake chamber inlet 1230. For example, vanes 1430 extend from the plates 1020 in FIG. 14. The vanes 1430 effectively increase the orifice size of the inlets 1230 to reduce fluid frictions. In various embodiments, vanes 1430 can be joined to the ends of the plates 1020. In other embodiments, the vanes 1430 are integral with the plates 1020 and can be formed by bending the ends of the plates 1020 before assembling the heat exchanger 1010.

FIG. 15 shows a cross section 1500 taken along section 15-15 in FIG. 11 of the exhaust system 1000. Cross section 1500 shows multiple plates 1020 forming alternating intake chambers 1410 and exit chambers 1420 where the exit chambers 1420 are open to vent exhaust to the manifold 1120. The manifold 1130 can also include one or more vanes 1430 disposed relative to the exit chamber outlets 1330 in order to reduce resistance to fluid flow near the exit chamber outlets 1330. For example, a vane 1430 extends from the plate 1020 as shown in FIG. 15. In various embodiments, vanes 1430 also extend from the ends of the plates 1020 at the intake chamber outlets 1240 and the exit chamber inlets 1320 that communicate with the combustion chamber 1030.

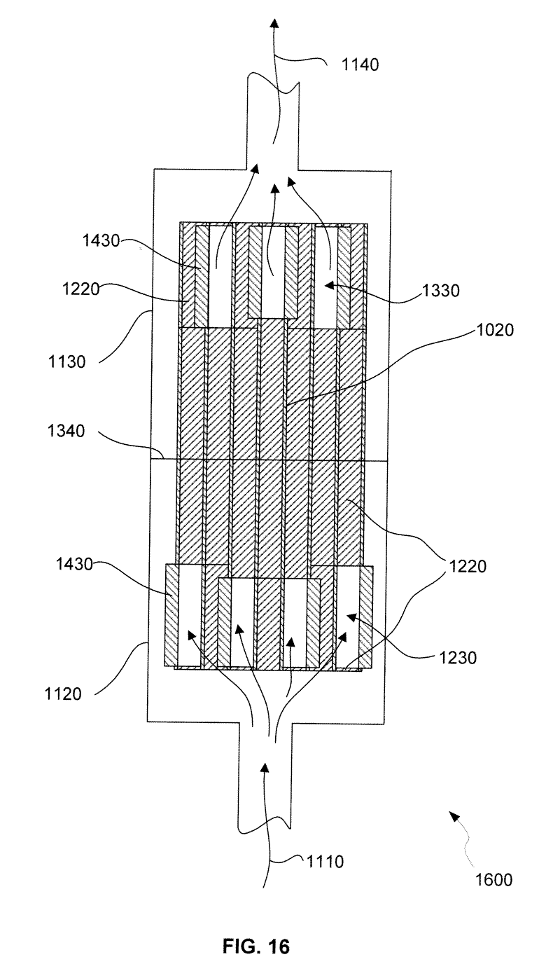

FIG. 16 shows a cross section 1600 taken along the section 16-16 of exhaust system 1000 of FIG. 10. Cross section 1600 shows an end-on view of multiple plates 1020, including the vanes 1430, and multiple spacers 1220 forming alternating intake chambers inlets 1230 and exit chambers outlets 1330. Also depicted in FIG. 16 is the baffle 1340 configured to prevent fluid communication between manifolds 1120 and 1130. In this configuration exhaust flows between plates in parallel, e.g., one time back and forth. However, in alternative embodiments, the exhaust may traverse back and for the between some of the plates more than once in series.

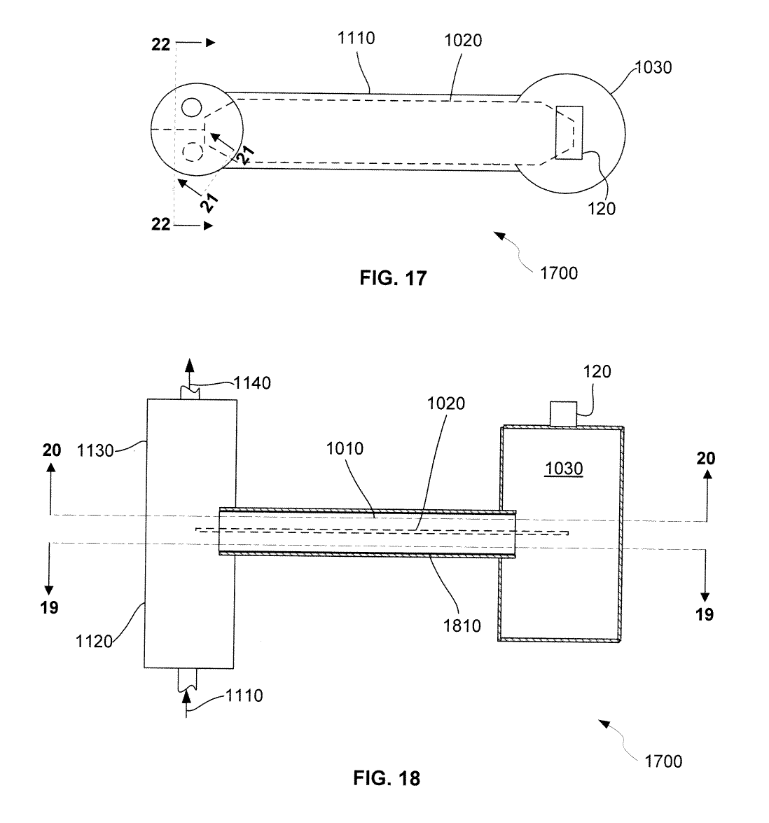

FIGS. 17 and 18 show top and front views, respectively, of another exemplary exhaust system 1700. The exhaust system 1700 is generally similar to the exhaust system 1000 but differs with respect to the orientation of the heat exchanger 1010. Specifically, the heat exchanger is rotated relative to the manifolds 1120, 1130 and/or the combustion chamber 1030 such that the transverse plane 1430 of the heat exchanger 1010 is aligned vertically rather than horizontally. Accordingly, the baffle 1340 is also rotated from horizontal to vertical.

Some embodiments of the exhaust system 1000, 1700 include insulation 1810 around the heat exchanger 1010 and the combustion chamber 1030, as shown in FIG. 18. The use of insulation reduces the amount of energy required to heat the exhaust gas within the combustion chamber 1030. More generally, it will be appreciated that insulation 1810 can be applied individually to any of the heat exchanger 1010, the combustion chamber 1030, and the manifold 1120, or to any combination of these components.

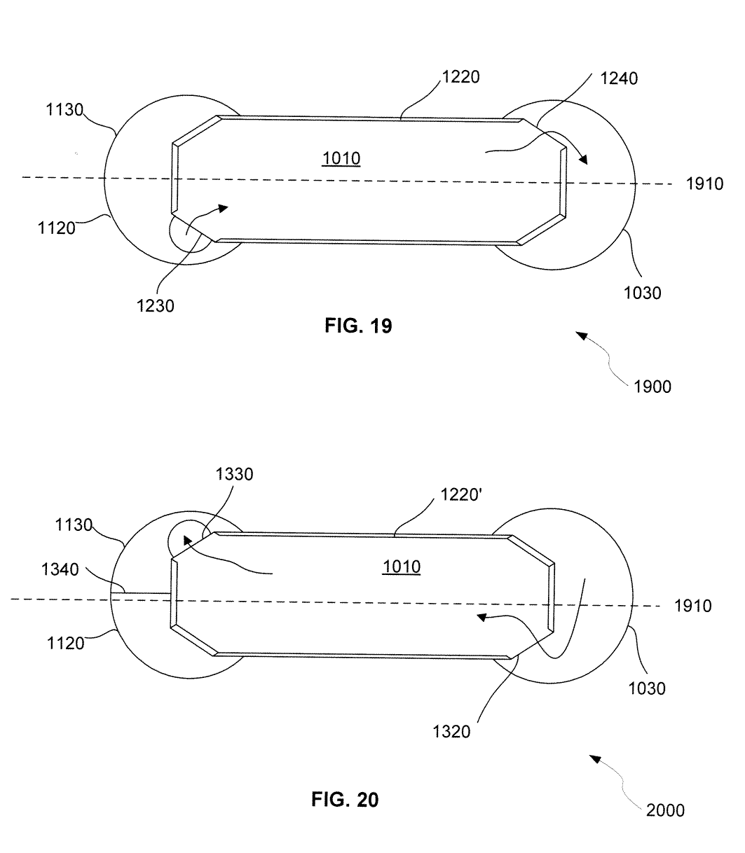

FIGS. 19 and 20 are cross sections of exhaust system 1700. In FIG. 19, a cross section 1900 is taken along section 19-19 in FIG. 18 through an intake chamber 1210, and in FIG. 20 a cross section 2000 is taken along the line 20-20 in FIG. 18 through an exit chamber 1310. As before, the intake chamber 1210 and the exit chamber 1310 are formed between the plate 1020, an exterior wall of the heat exchanger 1010, and spacers 1220. Openings between the spacers 1220 form the inlets 1230, 1320 and outlets 1240, 1330. The intake chamber 1210 is in fluid communication between the manifold 1120 and the combustion chamber 1030. The exit chamber 1310 is in fluid communication between the combustion chamber 1030 and the manifold 1130. In various embodiments, manifolds 1120 and 1130 consist of a continuous tube separated by a vertical baffle 1340.

The heat exchanger 1010 is again characterized by a transverse plane 1910 with the inlet 1230 below the transverse plane 1910 and the outlet 1240 above the transverse plane 1910. Likewise, the inlet 1320 is below the transverse plane 1910 and the outlet 1330 is above the transverse plane 1910. The inlets 1230, 1320 and outlets 1240, 1330 are on opposite sides of the transverse plane 1910 so that fluid flows diagonally through the chambers 1210, 1310.

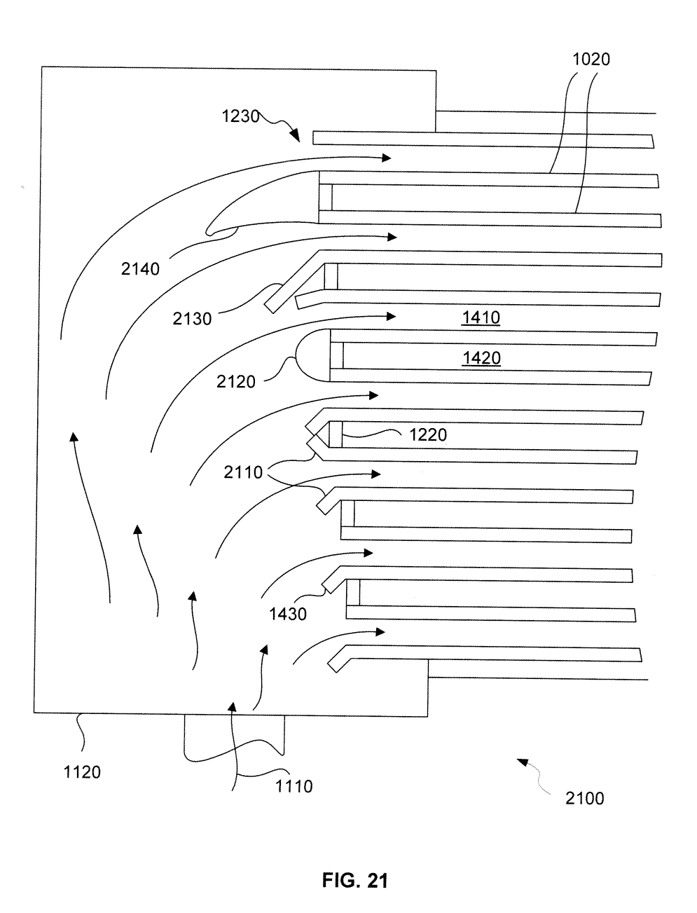

FIG. 21 shows a cross section 2100 taken along the section 21-21 within manifold 1120 of exhaust system 1700. Cross section 2100 shows multiple plates 1020 forming alternating intake chambers 1410 and exit chambers 1420. As above, each chamber 1410, 1420 is formed between two plates 1020 and spacers 1220. FIG. 21 shows a number of alternative concepts for vanes 1430 that can extend from the ends of the plates 1020. In some embodiments, vanes 2110 are disposed on both sides of an opening. In other embodiments, vanes 2120 can be spherically shaped, vanes 2130 can be of different lengths, and vanes 2140 can be aerodynamically shaped. When vanes 1430 on successive openings increasingly extend into a manifold, as in FIGS. 14 and 15, or as the succession of vanes 2120, 2130, and 2140, the vanes 1430 are said to be “feathered.” Feathering further helps to direct flow within the respective manifold to reduce flow friction loses.

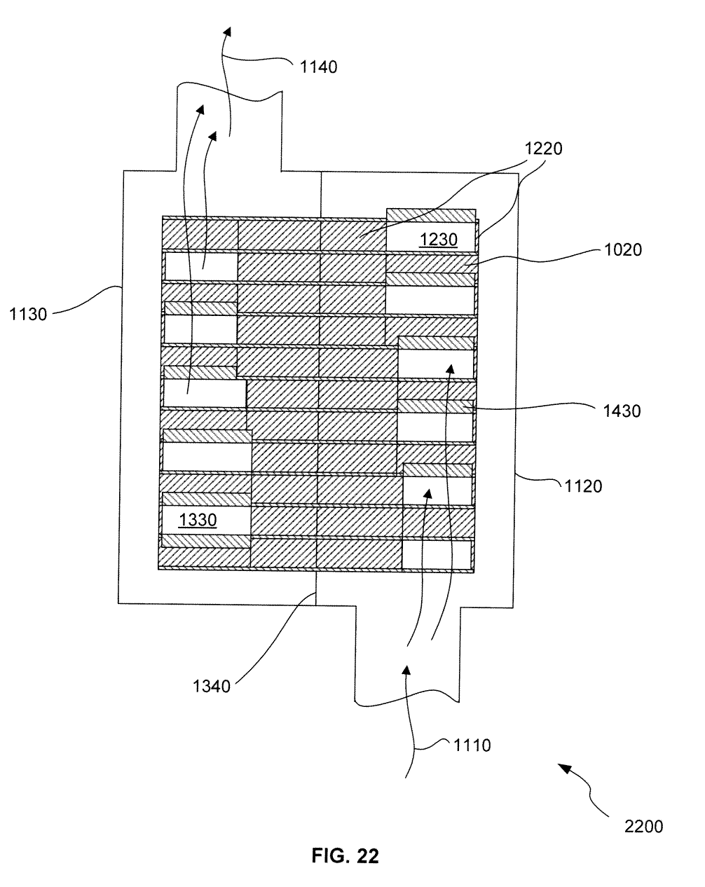

FIG. 22 shows a cross section 2200 taken along section 22-22 of exhaust system 1700. Cross section 2200 shows multiple plates 1020, including vanes 1430, and multiple spacers 1220 forming alternating intake chambers inlets 1230 and exit chambers outlets 1330. Also depicted is baffle 1340 configured to prevent fluid communication between manifolds 1120 and 1130. It will be appreciated that in these embodiments the manifolds 1120 and 1130 define separate but parallel longitudinal axes. These axes are approximately perpendicular to a plane defined by the plate 1020 and parallel to the transverse surface 1250.

Several further advantages of reverse flow heat exchangers 1010 should be noted. For example, these heat exchangers are self-cleaning. It will be appreciated that should a deposit form on an internal surface of one of the plates 1020, the restriction to the flow of exhaust gas around the deposit will tend to cause a local increase in the temperature at the restriction. Eventually, the local temperature increase will reach an ignition temperature of the deposit material, causing the deposit to burn away. Another advantage of the heat exchangers 1010 is that the heated internal surfaces of the chambers 1210, 1310 reduce the resistance to fluid flow through the chambers 1210, 1310 thereby lowering head loss through the exhaust system 1000. Further, it will be appreciated that the heat exchangers 1010 can serve to muffle sound due to the expansions and contractions that the exhaust gas goes through as it passes through successive openings. The muffling effect can be further enhanced by tuning the dimensions of the chambers to behave as resonating chambers. Accordingly, heat exchangers 1010 can replace mufflers on vehicles or dampen the sounds of fans.

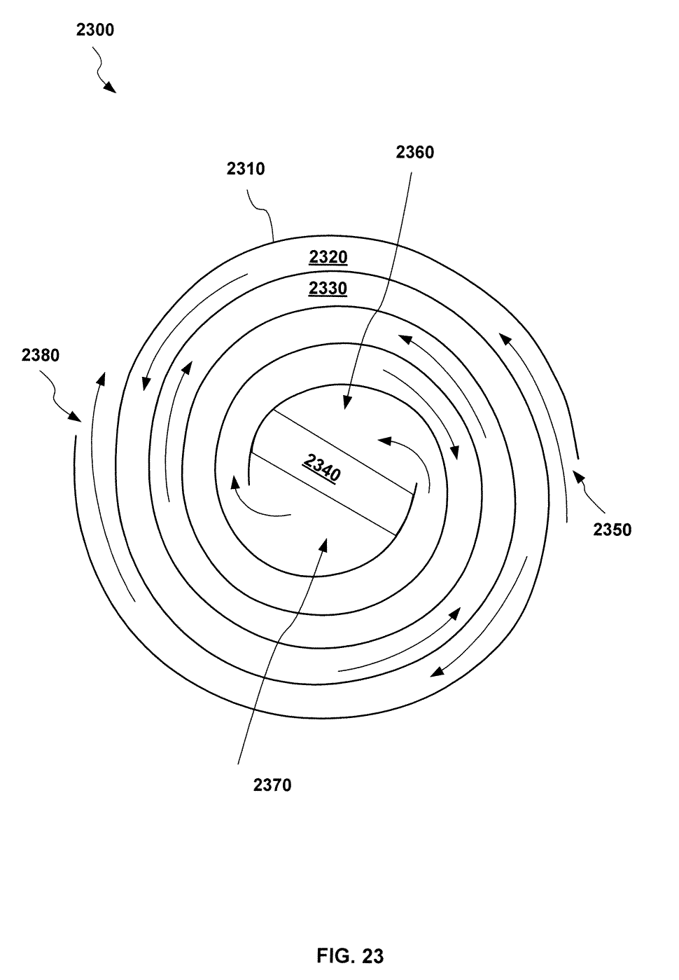

FIG. 23 depicts a cross sectional view of still another embodiment 2300 of the invention comprising a particle burner including a catalyst booster. Embodiment 2300 is an alternative embodiment of the exhaust systems illustrated elsewhere herein. The system illustrated in FIG. 23 is an alternative embodiment of the systems illustrated in prior figures. The cross section depicted is taken perpendicular to a vertical axis of the embodiment 2300. Specifically, the embodiment 2300 comprises a reverse flow heat exchanger 2310 and a gas permeable catalyst 2340. The heat exchanger 2310 comprises two interleaved ducts, an incoming duct 2320 and an outgoing duct 2330. Each duct 2320 and 2330 is spiral-wound around a central volume that optionally includes the catalyst 2340. The ducts 2320 and 2330 are in fluid communication with each other across the central volume and through the catalyst 2340. The incoming duct 2320 comprises an inlet 2350 and the outgoing duct 2330 comprises an outlet 2380. The catalyst 2340 separates the central volume into first and second regions 2360 and 2370. The incoming duct 2320 opens into the first region 2360 and the outgoing duct 2330 opens into the second region 2370. In alternative embodiments, all or part of the catalyst 2340 is disposed in outgoing duct 2330.

The inlet 2350 is an opening through which exhaust enters the incoming duct 2320 of the heat exchanger 2310. The exhaust flows through the incoming duct 2320 to the central volume. The exhaust then exits the central volume, travels through the outgoing duct 2330, and leaves the heat exchanger 2310 via the outlet 2380.

As the exhaust traverses the central volume or before the central volume, particles within the exhaust are heated to an ignition temperature and therefore combust. Additionally, gases within the exhaust that result from incomplete fuel combustion are oxidized as they pass through the catalyst 2340. Catalyst 2340 is optionally disposed in other locations within the embodiment 2300. For example, the catalyst 2340 may be disposed within the exit duct 2330.

The combustion of the particles and the oxidation of these gases at the catalyst 2340 both give off heat which heats the catalyst 2340 and the exhaust within the central volume. In various embodiments, the heat generated from these exothermic reactions is sufficient to maintain the catalyst 2340 at an operating temperature of approximately 900-1000, 1000-1000 or greater than 1100° F. The ability to operate at high operating temperatures, those above the ignition temperature of the particles, alleviates the need for a particle trap in the exhaust system.

As noted, the exiting exhaust is hotter than the entering exhaust, and as the exhaust travels through outgoing duct 2330, heat is transferred through the duct walls to warm the exhaust in the incoming duct 2320. Recovery of heat in this manner boosts the energy efficiency of the embodiment 2300. It should also be noted that the heat exchanger 2310 acts as insulation for the catalyst 2340, thus making the embodiment 2300 safer.

The catalyst 2340 can comprise a substrate supporting a catalytic material, for example. In various embodiments, the catalytic material is added to a washcoat and applied to the substrate. The washcoat provides increased surface area for the catalytic material. Exemplary substrates comprise a mesh of stainless steel or a porous ceramic, but other suitable materials will be familiar to those skilled in the art. Suitable catalytic materials include platinum, palladium, and rhodium, but other suitable materials will be familiar to those skilled in the art. An exemplary washcoat comprises a mixture of silicon and aluminum, but other suitable materials familiar to those skilled in the art can be employed. Alternatively, the catalyst 2340 can comprise a simple mesh of the catalytic material without a substrate, or a catalytic material deposited directly onto a substrate.

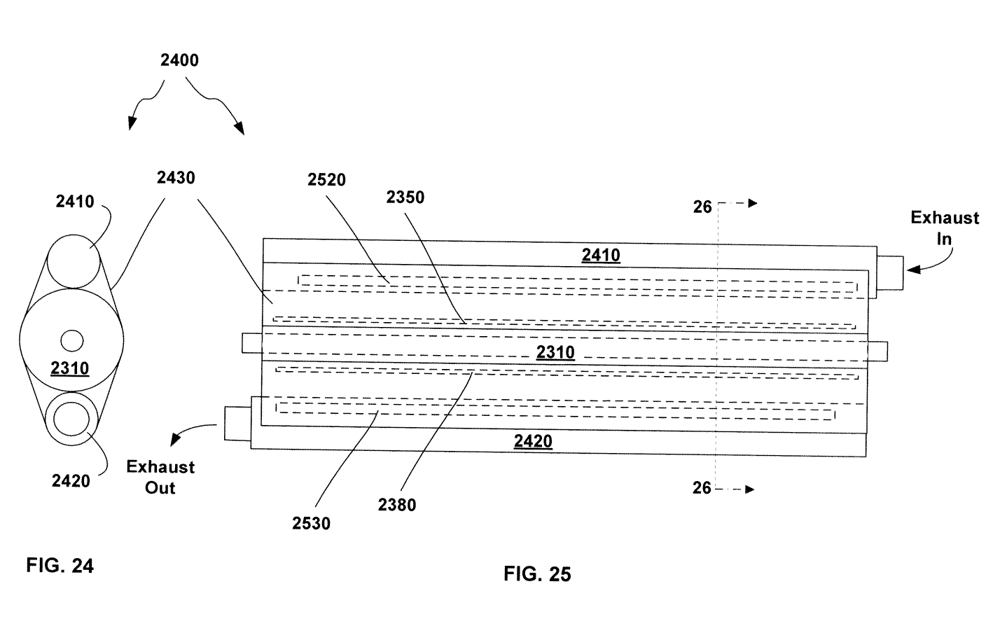

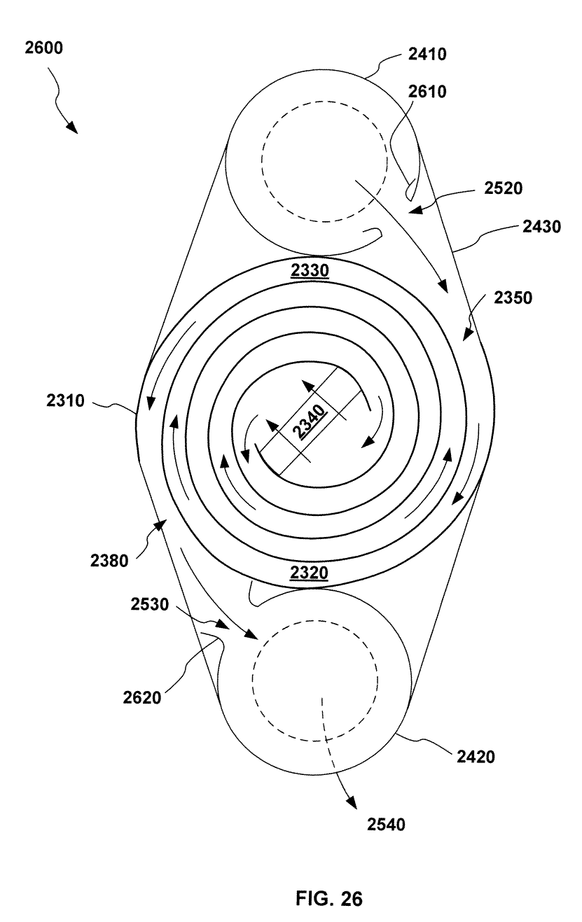

FIGS. 24 and 25 show top and side views, respectively, of an exemplary exhaust cleaner 2400 in accordance with an embodiment of the invention. FIG. 26 depicts a cross section 2600 of the exhaust cleaner 2400 taken along section 26-26 of FIG. 25. The exhaust cleaner 2400 is generally applicable and can be used, for example, in conjunction with any of the sources of particle laden air discussed elsewhere herein. In these applications, the exhaust cleaner 2400 can replace the catalytic converter, particle trap, and/or the muffler.

The exhaust cleaner 2400 comprises a reverse flow heat exchanger 2310, a catalyst 2340, an inlet chamber 2410, an outlet chamber 2420, and an enclosure 2430. The inlet chamber 2410 includes a portal 2520 (see FIG. 26) and the outlet chamber 2420 includes a portal 2530 (FIG. 26). The portals 2520 and 2530 allow the inlet chamber 2410 and the outlet chamber 2420, respectively, to be in fluid communication with the heat exchanger 2310. The enclosure 2430 is disposed around the reverse flow heat exchanger 2310 and the inlet and outlet chambers 2410, 2420. For use with a tractor truck, the exhaust cleaner 2400 is generally approximately seven feet long. Dimensions of the exhaust cleaner 2400 may be designed to allow for easy substitution for the mufflers of existing exhaust systems. The generally oblong cross-section of exhaust cleaner 2400, as illustrated in FIG. 26, may provide aerodynamic advantages in vehicle use.

As shown in FIG. 25, exhaust from an internal combustion engine initially enters from one end of the inlet chamber 2410. The exhaust leaves the inlet chamber 2410 through the portal 2520 and enters the heat exchanger 2310. The exhaust spirals in through the heat exchanger 2310, passes through the catalyst 2340, and then spirals out again through the heat exchanger 2310. The exhaust then exits the heat exchanger 2310 through portal 2530 to the outlet chamber 2420 and out of the exhaust cleaner 2400.

In some embodiments, inlet chamber 2410 comprises vanes 2610 that protrude into the inlet chamber 2410 at the portal 2520. Likewise, outlet chamber 2420 can comprise vanes 2620 extending outward at the portal 2530. Vanes and their advantages are discussed elsewhere herein. In some embodiments, the ducts, portals, inlets and outlets may be feathered as also discussed elsewhere herein.

The exhaust cleaner 2400 can also include a means (not shown) for pre-heating the exhaust before the exhaust reaches the catalyst 2340 to permit catalysis to occur at a desired operating temperature, such as 900° C. This may be necessary for a short period of time after a cold engine, for instance. The means for pre-heating may be disposed near the inlet chamber 2410 or anywhere within the flow path between the inlet chamber 2410 and the catalyst 2340. The means for pre-heating can be, for example, an instance of energy source 120 or any means for heating discussed elsewhere herein. The exhaust cleaner 2400 can also include a control circuit (not shown) to monitor the catalyst 2340 and to control the means for pre-heating.

Typically, the enclosure 2430, the heat exchanger 2310, and the inlet and outlet chambers 2410 and 2420 are made from stainless steel, titanium, and/or ceramics, but other suitable materials will be familiar to those skilled in the art. Typically, the walls separating the ducts 2320, 2330 are constructed of a material with a high thermal conductivity, such as a metal (e.g., copper, steal, or nickel), to provide good heat transfer from the outgoing duct 2330 to the incoming duct 2320.

An exemplary method for manufacturing the exhaust cleaner 2400 comprises attaching opposite sides of the catalyst 2340 to the ends of two metal sheets. The metal sheets are then wrapped around the catalyst 2340 to form the ducts 2320, 2330 of the reverse flow heat exchanger 2310. A spacer placed at either side of one of the two sheets can be used to maintain the proper spacing between the ducts 2320, 2330. After the sheets have been wrapped around catalyst 2340, the inlet and outlet chambers 2410 and 2420 can be attached to the reverse flow heat exchanger 2310. An enclosure can then be wrapped around the entire assembly, or further metal sheets can be attached to span between the chambers 2410, 2420 and the reverse flow heat exchanger 2310 to fully enclose the flow path of the exhaust. Lastly, end caps can be attached to the assembly to seal the ends. In some embodiments, one or more of these end caps are removable for easy replacement of the catalyst. For example, one of the end caps could be threaded or tack welded. The catalyst is mounted on a support structure that can be removed when one of the end caps are removed. The exhaust cleaner 2400 may include slots, tracks, guides, or the like to receive the catalyst support structure.

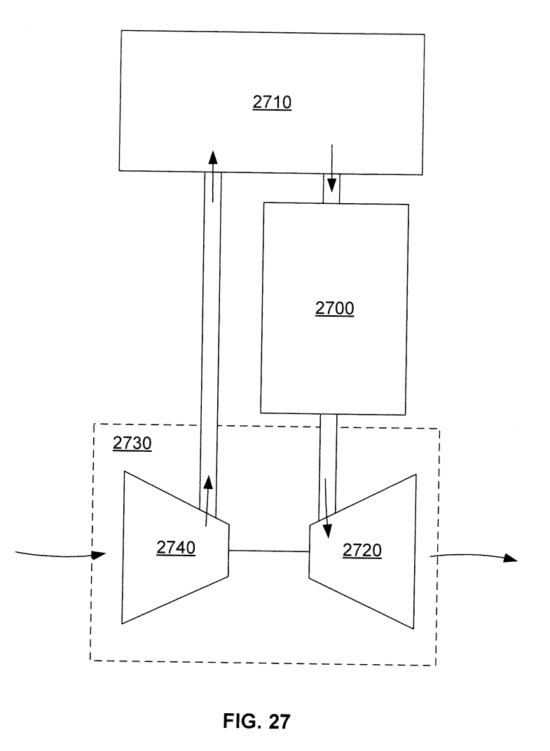

FIG. 27 depicts a schematic representation of a particle burner 2700 disposed between an engine 2710 and a turbine 2720 of a turbo charger 2730 in accordance with an embodiment of the invention. In various embodiments, the particle burner 2700 comprises the exhaust cleaner 2400 (FIG. 24) or other exhaust systems illustrated herein As shown in FIG. 27, air enters the turbo charger 2730 and is compressed by an impeller 2740 of the turbo charger 2730 before entering the engine 2710. Exhaust from the engine 2710 passes through the particle burner 2700 before returning to the turbo charger 2730 where the exhaust powers the turbine 2720.

Since the turbine 2720 operates at a relatively high pressure, i.e., between about two and ten atmospheres, the pressure within the particle burner 2700 is also elevated relative to the ambient air pressure. A higher pressure within the particle burner 2700 is beneficial because a catalyst within the particle burner 2700, such as catalyst 2340 (FIG. 23), oxidizes the gaseous products of incomplete combustion more efficiently. Thus, the catalyst can employ less catalytic material to achieve similar results as a catalyst that operates at a lower pressure. In some embodiments, the weight of catalytic material in the catalyst (e.g., catalyst 2340) is about 50% or less of the weight of catalytic material in a catalyst disposed in an exhaust system of the prior art. For example, an automotive catalytic converter of the prior art may include between 3 and 7 grams of platinum while various embodiments of the invention (e.g., illustrated in FIGS. 5A-27) may achieve better catalysis with less than 3.0, 2.5, 2.0 or 1.5 grams.

It should be noted that placing the particle burner 2700 between the engine 2710 and the turbo charger 2730 creates a longer air path between these two components. This longer air path can create an increased lag which may reduce the efficiency of the turbo charger 2730. In various embodiments, a feedback system can compensate for the reduced efficiency of the turbo charger 2730. In some embodiments, the control system is also coordinated with a bypass system (not shown) of the turbo charger 2730 that allows excess exhaust to bypass the turbo charger 2730. In some embodiments, combustion of particles may heat the gas and increase its pressure, thus increasing efficiency of the turbo charger 2730.

Several embodiments are specifically illustrated and/or described herein. However, it will be appreciated that modifications and variations are covered by the above teachings and within the scope of the appended claims without departing from the spirit and intended scope thereof. For example, while the specification discusses separate parts of the reverse flow heat exchanger and a combustion chamber, there may not be distinct boundaries between these elements. Further, non-combustible particle such as ash are optionally separated and captured following the combustion chamber 110 using a centrifugal particle separator. Such separators are known in the art, see for example U.S. Pat. No. 7,258,713. Exhaust systems discussed herein, such as exhaust system 100 are optionally disposed in parallel arrays or clusters.

The embodiments discussed herein are illustrative of the present invention. As these embodiments of the present invention are described with reference to illustrations various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a reverse flow heat exchanger including an inlet configured to receive a particle laden gas; and
a continuous energy source configured to add energy to the gas at an intermediate point within the reverse flow heat exchanger such that gas heated by the energy source pre-heats gas arriving though the input of the reverse flow heat exchanger and raises the gas to a combustion temperature of the particles.

2. The system of claim 1, further comprising a source of the particle laden gas.

3. The system of claim 1, further comprising an engine and a turbo charger, the turbo charger comprising an impeller and a turbine, the reverse flow heat exchanger being disposed between the engine and the turbine.

4. The system of claim 1, further comprising a bypass manifold configured to allow some of the particle laden gas to bypass the reverse flow heat exchanger.

5. The system of claim 1, further comprising a catalyst disposed within the reverse flow heat exchanger.

6. The system of claim 1, further comprising a catalyst disposed within the reverse flow heat exchanger at a position at or after which the combustion temperature of the particles is reached.

7. The system of claim 1, further comprising a catalyst disposed within the reverse flow heat exchanger, an operating temperature of the catalyst being lower than the combustion temperature of the particle.

8. The system of claim 1, further comprising a catalyst disposed within the reverse flow heat exchanger such that particles within the particle laden gas are combusted upon or prior to reaching the catalyst.

9. The system of claim 1, further comprising a control circuit configured to control an amount of energy provided by the energy source to the gas.

10. The system of claim 9, wherein the control circuit is configured to adjust the amount of energy provided by the energy source responsive to an amount of energy generated by combustion of the particles.

11. The system of claim 1, wherein the energy source is configured to generate microwaves.

12. The system of claim 1, wherein the energy source comprises an electrical heater.

13. The system of claim 1, wherein the reverse flow heat exchanger is configured such that gas flow through the reverse flow heat exchanger is provided by heating of the gas by the energy source.

14. The system of claim 1, further comprising a fan configured to provide flow of the particle laden gas through the reverse flow heat exchanger.

15. The system of claim 1, wherein the reverse flow heat exchanger is spiral-wound.

16. The system of claim 1, wherein the reverse flow heat exchanger is disposed in a stacked geometry.

17. The system of claim 1, wherein the reverse flow heat exchanger functions as both as part of a muffler and part of a catalytic converter.

18. The system of claim 1, wherein the particle laden gas includes an exhaust of a vehicle engine.

19. The system of claim 1, wherein the particle laden gas includes an exhaust of a power plant.

20. A vehicle comprising:
an engine;
a reverse flow heat exchanger configured to receive an exhaust of the engine; and
a catalyst disposed within the reverse flow heat exchanger such that heat generated by reaction of the exhaust with the catalyst preheats the exhaust to a combustion temperature of particles within the exhaust before the exhaust reaches the catalyst.

21. The vehicle of claim 20, further comprising an energy source disposed within the reverse flow heat exchanger and configured to heat the exhaust prior to the exhaust reaching the catalyst.

22. The vehicle of claim 21, wherein the energy source is disposed such that particles within the exhaust are combusted prior to reaching the catalyst.

23. The vehicle of claim 21, further comprising a control circuit configured to control the energy sources so as to maintain the catalyst at a working temperature.

24. A method comprising:
(a) providing a particle laden gas to the input of a reverse flow heat exchanger;
(b) heating the gas within the reverse flow heat exchanger using a continuous energy source;
(c) using the heated gas to pre-heat the particle laden gas provided to the input to create a temperature ladder; and
(d) continuing the steps (a)-(c) until a combustion temperature of the particles is reached within the heat exchanger.

25. The method of claim 24, wherein the particle laden gas includes a power plant exhaust.

26. The method of claim 24, further comprising passing the gas through a catalyst following combustion of the particles.

27. The method of claim 24, further comprising driving a turbine using the gas following combustion of the particles.

28. The method of claim 24, wherein the reverse flow heat exchanger includes a spiral configuration.

29. A method comprising:
(a) operating an engine;
(b) receiving an exhaust of the engine at an input of a reverse flow heat exchanger;
(c) passing the exhaust through a catalyst within the reverse flow heat exchanger, reaction of the exhaust and the catalyst resulting in heating of the catalyst and exhaust;
(d) using the heated exhaust to preheat the exhaust at the input of the reverse flow heat exchanger such that preheated exhaust arrives at the catalyst; and
(e) continuing the steps (a)-(d) such that the catalyst reaches a preferred operating temperature more rapidly than would occur without the reverse flow heat exchanger.

30. The method of claim 29., further comprising using, an energy source to preheat the exhaust gas within the reverse flow heat exchanger, the exhaust gas being preheated to a combustion temperature of particles within the exhaust gas prior to reaching the catalyst.

31. The method of claim 29, further comprising using an external energy source including a resistive heater, a microwave source, or an inductive heater, to heat the exhaust gas.
